(19) United States
(12) Patent Application Publication
(10) Pub. No.: US 2011/0254827 A1
(43) Pub. Date: Oct. 20, 2011

(54) DISPLAY DEVICE

(76) Inventors: Kei TAMURA, Saitama (JP); Takumi Shigaki, Mobara (JP); Hideo Sato, Hitachi (JP); Shouji Nagao, Chiba (JP); Mitsuru Goto, Chiba (JP)

(21) Appl. No.: 13/088,482

(22) Filed: Apr. 18, 2011

(30) Foreign Application Priority Data
Apr. 19, 2010 (JP) 2010-095719

(51) Int. Cl. G06F 3/038

(52) U.S. Cl. 345/212

(57) ABSTRACT

Provided are a display device and a method of driving the same, improving display quality by suppressing abnormal changes resulting from parasitic capacitance. The display device includes first and second pixel circuits having first and second switching elements and first and second display electrodes; and a display control voltage supply unit supplying a display control voltage to the first and second display electrodes. In a first write period, the display control voltage supply unit turns ON the first and second switching elements and supplies a display control voltage corresponding to display data of the first pixel circuit to the first and second display electrodes. In a second write period, the display control voltage supply unit maintains the switch of the second switching element to be in the ON state and supplies a display control voltage corresponding to display data of the second pixel circuit to the second display electrode.

### CROSS-REFERENCE TO RELATED APPLICATION

The present application claims priority from Japanese patent application JP 2010-095719 filed on Apr. 19, 2010, the content of which is hereby incorporated by reference into this application.

### BACKGROUND OF THE INVENTION

1. Field of the Invention

The invention relates to a display device and a method of driving the same, and more particularly, to a display device in which display quality is improved by suppressing abnormal changes in the potential of a display electrode resulting from a parasitic capacitance existing in a pixel circuit.

2. Description of the Related Art

In a display device in which a plurality of pixel circuits is arranged on a display panel, the pixel circuit includes a transistor which is one of the switching elements. A scanning signal line is connected to the gate electrode of the transistor, and a data signal line and a display electrode are connected to the input and output sides of the transistor, respectively. When the scanning signal line changes to HIGH voltage for a predetermined period, during that period, the HIGH voltage is applied to the gate electrode of the transistor through the scanning signal line, and the transistor is turned ON. During the ON period of the transistor, a display control voltage in accordance with display data of the pixel circuit is supplied from the data signal line to a pair of the display electrode and reference electrode of the pixel circuit. After the elapse of the predetermined period, the scanning signal line returns to LOW voltage, the LOW voltage is applied to the gate electrode of the transistor, and the transistor is turned OFF. Even after the transistor is turned OFF, the display control voltage is maintained and the pixel circuit still performs its display operation.

Generally, in a display region of a display panel, a plurality of pixel circuits are arranged in a matrix form, one scanning signal line extending in the horizontal direction is disposed in parallel to a plurality of pixel circuits arranged on one row in the horizontal direction, and one data signal line extending in the vertical direction is disposed in parallel to a plurality of pixel circuits arranged on one column in the vertical direction. For example, when the display device is a liquid crystal display device, the display electrode is a pixel electrode and the reference electrode is a common electrode.

FIG. 12 is a circuit diagram showing the control of a display panel of a liquid crystal display device according to the related art. In FIG. 12, the plurality of scanning signal lines are denoted as scanning signal lines Gₙ and Gₙ₋₁, the plurality of data signal lines are denoted as data signal lines Dₙ, Dₙ₊₁, and Dₙ₋₂, and reference voltage lines supplying a reference potential to common electrodes CT are denoted as reference voltage lines CL.

JP2001-51252A is an example of the related art.

### SUMMARY OF THE INVENTION

When display electrodes provided in two pixel circuits are formed in the same layer, and these display electrodes are not separated by a sufficient distance, a parasitic capacitance exists between these display electrodes. As described above, the transistor of an n-th pixel circuit which is a certain pixel circuit is turned ON, a display control voltage is supplied to the pair of the display electrode and the common electrode of the n-th pixel circuit, and the display control voltage is maintained even after the transistor is turned OFF. After that, the transistor of an (n+1)th pixel circuit which is another pixel circuit is turned ON, and a display control voltage is supplied to the pair of the display electrode and the common electrode of the(n+1)th pixel circuit.

At this time, due to the parasitic capacitance existing between the display electrode of the n-th pixel circuit and the display electrode of the (n+1)th pixel circuit, capacitive coupling takes place between the display electrode of the n-th pixel circuit and the display electrode of the (n+1)th pixel circuit. Through the capacitive coupling, a part of the display control voltage supplied to the pair of the display electrode and the common electrode of the (n+1)th pixel circuit is added to the display control voltage maintained between the display electrode and the common electrode of the n-th pixel circuit. As a result, a voltage different from the display control voltage corresponding to the display data of the n-th pixel circuit is maintained in the n-th pixel circuit, and accordingly, a display abnormality occurs in the n-th pixel circuit.

FIG. 13 is a diagram showing a method of driving the liquid crystal display device according to the related art. The scanning signal line Gₙ is connected to the gate electrode of the transistor of the n-th pixel circuit, and the pixel electrode PTₙ is connected to the output side of the transistor. Similarly, the scanning signal line Gₙ₊₁ is connected to the gate electrode of the transistor of the (n+1)th pixel circuit, and the pixel electrode PTₙ₊₁ is connected to the output side of the transistor. The potentials of the common electrodes CT provided to the n-th pixel circuit and the (n+1)th pixel circuit are the same, and the potentials of the respective common electrodes CT change together.

In FIG. 13, the changes over time of the respective potentials of the common electrode CT, the scanning signal line Gₙ, the scanning signal line Gₙ₊₁, and the pixel electrodes PT are shown in that order from the top. In the potentials of the pixel electrodes PT, the potential of the pixel electrode PTₙ of the n-th pixel circuit and the potential of the pixel electrode PTₙ₊₁ of the (n+1)th pixel circuit are superimposed. In FIG. 13, for the sake of simplicity, a case in which the display data of the n-th pixel circuit and the (n+1) th pixel circuit are the same, and the display control voltages to be supplied are the same is shown.

As described above, the scanning signal line Gₙ changes to HIGH voltage for a predetermined period, and during that period, a display control voltage is supplied to the pair of the pixel electrode PTₙ and the common electrode CT of the n-th pixel circuit. In this way, the potential of the pixel electrode PTₙ changes from −V_{LCD} to V_{LCD}. After that, the scanning signal line Gₙ₊₁ changes to HIGH voltage for a predetermined period, and during that period, a display control voltage is supplied to the pair of the pixel electrode PTₙ₊₁ and the common electrode CT of the (n+1)th pixel circuit. In this way, the potential of the pixel electrode PTₙ₋₁ changes from −V_{LCD} to V_{LCD}. In that period, as described above, due to a parasitic capacitance, a part of the display control voltage supplied to the pair of the pixel electrode PTₙ₋₁ and the common electrode CT is added to the display control voltage maintained between the pixel electrode PT_{˜} and the common electrode CT. Thus, the potential of the pixel electrode PTₙ rises above V_{LCD}. In the figure, this change is shown as voltage ΔV. The voltage ΔV which is an abnormal change in the potential of the display electrode causes display abnormalities.

The invention is made in view of the problems described above, and an object of the invention is to provide a display device in which display quality is improved by suppressing abnormal changes in the potential of a display electrode resulting from a parasitic capacitance existing in a pixel circuit and to provide a method of driving the same.

(1) In order to solve the above-described problems, according to the invention, there is provided a display device including a first pixel circuit having a first switching element and a first display electrode; a second pixel circuit having a second switching element and a second display electrode; and a display control voltage supply unit supplying a display control voltage to the first and second display electrodes through the first and second switching elements, respectively, wherein in a first write period, the display control voltage supply unit turns ON a switch of the first switching element, supplies a display control voltage corresponding to display data of the first pixel circuit to the first display electrode, turns ON a switch of the second switching element in synchronization with the time when the switch of the first switching element is turned ON, and supplies the display control voltage corresponding to the display data of the first pixel circuit to the second display electrode, and wherein in a second write period continuous to the first write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

(2) In the display device according to (1), in a third write period after the first and second write periods, the display control voltage supply unit may turn ON the switch of the second switching element, supply a display control voltage corresponding to display data of the second pixel circuit to the second display electrode, turn ON the switch of the first switching element in synchronization with the time when the switch of the second switching element is turned ON, and supply the display control voltage corresponding to the display data of the second pixel circuit to the first display electrode, and in a fourth write period continuous to the third write period, the display control voltage supply unit may maintain the switch of the first switching element to be in the ON state, turn OFF the switch of the second switching element, and supply a display control voltage corresponding to display data of the first pixel circuit to the first display electrode in synchronization with the time when the switch of the second switching element is turned OFF.

(3) In the display device according to (2), the display control voltage supply unit may alternately repeat the control performed in the first and second write periods and the control performed in the third and fourth write periods to thereby sequentially supply display control voltages corresponding to display data of the first and second pixel circuits to the first and second display electrodes in synchronization with the time when the display control voltage is supplied to the first and second display electrodes.

(4) In the display device according to (1) to (3), output sides of the first and second switching elements may be connected to the first and second display electrodes, respectively, the display control voltage supply unit may further include a data signal wiring connected to each of input sides of the first and second switching elements, and the display control voltage supply unit may apply the display control voltage to the data signal wiring to thereby supply a display control voltage to a display electrode connected to an output side of a switching element being in the ON state among the first and second switching elements.

(5) In the display device according to (4), the display control voltage supply unit may further include a first gate wiring connected to the switch of the first switching element and a second gate wiring connected to the switch of the second switching element, and the display control voltage supply unit may apply an ON voltage to the first and second gate wirings to thereby turn ON the switches of the first and second switching elements, respectively.

(6) The display device according to (1) may further include a third pixel circuit having a third switching element and a third display electrode and arranged along the first pixel circuit, and a fourth pixel circuit having a fourth switching element and a fourth display electrode and arranged along the second pixel circuit; the display control voltage supply unit may supply a display control voltage to the third and fourth display electrodes through the third and fourth switching elements, respectively; when displaying images in a normal scan mode, in a third write period continuous to the second write period, the display control voltage supply unit may turn ON a switch of the third switching element, supply a display control voltage corresponding to the display data of the third pixel circuit to the third display electrode, turn ON a switch of the fourth switching element in synchronization with the time when the switch of the third switching element is turned ON, supply the display control voltage corresponding to the display data of the third pixel circuit to the fourth display electrode; in a fourth write period continuous to the third write period, the display control voltage supply unit may maintain the switch of the fourth switching element to be in the ON state, turn OFF the switch of the third switching element, and supply a display control voltage corresponding to display data of the fourth pixel circuit to the fourth display electrode in synchronization with the time when the switch of the third switching element is turned OFF; and when displaying images in a reverse scan mode where the images are displayed in a reversed manner, in a fifth write period, the display control voltage supply unit may turn ON the switch of the third switching element, supply a display control voltage corresponding to display data of the third pixel circuit to the third display electrode, turn ON the switch of the fourth switching element in synchronization with the time when the switch of the third switching element is turned ON, and supply the display control voltage corresponding to the display data of the third pixel circuit to the fourth display electrode; in a sixth write period continuous to the fifth write period, the display control voltage supply unit may maintain the switch of the fourth switching element to be in the ON state, turn off the switch of the third switching element, and supply a display control voltage corresponding to display data of the fourth pixel circuit to the fourth display electrode in synchronization with the time when the switch of the third switching element is turned OFF; in a seventh write period continuous to the sixth write period, the display control voltage supply unit may turn ON the switch of the first switching element, supply a display control voltage corresponding to display data of the first pixel circuit to the first display electrode, turn ON the switch of the second switching element in synchronization with the time when the switch of the first switching element is turned ON, and supply the display control voltage corresponding to the display data of the first pixel circuit to the second display electrode; and in an eighth write period continuous to the seventh write period, the display control voltage supply unit may maintain the switch of the second switching element to be in the ON state, turn OFF the switch of the first switching element, and supply a display control voltage corresponding to display data of the second pixel circuit to the second display electrode in synchronization with the time when the switch of the first switching element is turned OFF.

(7) In the display device according to (6), output sides of the first to fourth switching elements maybe connected to the first to fourth display electrodes, respectively, and the display control voltage supply unit may further include a data signal wiring connected to each of input sides of the first to fourth switching elements, and the display control voltage supply unit may apply a display control voltage to the data signal wiring to thereby supply the display control voltage to a display electrode connected to an output side of a switching element being in the ON state among the first to fourth switching elements.

(8) In the display device according to (7), the display control voltage supply unit may further include a first gate wiring connected to the switch of the first switching element, a second gate wiring connected to the switch of the second switching element, a third gate wiring connected to the switch of the third switching element, and a fourth gate wiring connected to the switch of the fourth switching element; and the display control voltage supply unit may apply an ON voltage to the first to fourth gate wirings to thereby turn ON the switches of the first to fourth switching elements, respectively.

(9) In the display device according to (1), output sides of the first and second switching elements may be connected to the first and second display electrodes, respectively, and the display control voltage supply unit may further include a data signal wiring connected to each of the input sides of the first and second switching elements, and the display control voltage supply unit may supply a different voltage from a display voltage corresponding to the display data of the first pixel circuit to the data signal line in synchronization with the time when a reference potential serving as the reference of the display control voltage supplied to the first and second pixel electrodes changes to a different potential.

(10) In the display device according to (9), the different voltage may be a voltage higher than the display voltage corresponding to the display data of the first pixel circuit when the reference voltage changes from a high voltage to a low voltage and may be a voltage lower than the display voltage corresponding to the display data of the first pixel circuit when the reference voltage changes from a low voltage to a high voltage.

(11) According to the invention, there is provided a method of driving a display device including a first pixel circuit having a first switching element and a first display electrode; a second pixel circuit having a second switching element and a second display electrode; and a display control voltage supply unit supplying a display control voltage to the first and second display electrodes through the first and second switching elements, respectively, the method including: a step wherein in a first write period, the display control voltage supply unit turns ON a switch of the first switching element, supplies a display control voltage corresponding to display data of the first pixel circuit to the first display electrode, turns ON a switch of the second switching element in synchronization with the time when the switch of the first switching element is turned ON, and supplies the display control voltage corresponding to the display data of the first pixel circuit to the second display electrode, and a step wherein in a second write period continuous to the first write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

(12) The method according to (11) may further include a step wherein in a third write period after the first and second write periods, the display control voltage supply unit turns ON the switch of the second switching element, supplies a display control voltage corresponding to display data of the second pixel circuit to the second display electrode, turns ON the switch of the first switching element in synchronization with the time when the switch of the second switching element is turned ON, and supplies the display control voltage corresponding to the display data of the second pixel circuit to the first display electrode, and a step wherein in a fourth write period continuous to the third write period, the display control voltage supply unit maintains the switch of the first switching element to be in the ON state, turns OFF the switch of the second switching element, and supplies a display control voltage corresponding to display data of the first pixel circuit to the first display electrode in synchronization with the time when the switch of the second switching element is turned OFF.

(13) In the method according to (12), the display control voltage supply unit may alternately repeat the steps for the control performed in the first and second write periods and the steps for the control performed in the third and fourth write periods to thereby sequentially supply display control voltages corresponding to display data of the first and second pixel circuits to the first and second display electrodes in synchronization with the time when the display control voltage is supplied to the first and second display electrodes.

(14) In the method according to (11) to (13), output sides of the first and second switching elements may be connected to the first and second display electrodes, respectively, and the display control voltage supply unit may further include a data signal wiring connected to each of input sides of the first and second switching elements, and in the respective steps, the display control voltage supply unit may apply a display control voltage to the data signal wiring to thereby supply the display control voltage to a display electrode connected to an output side of a switching element being in the ON state among the first and second switching elements.

(15) In the method according to (14), the display control voltage supply unit may further include a first gate wiring connected to the switch of the first switching element and a second gate wiring connected to the switch of the second switching element, and in the respective steps, the display control voltage supply unit may apply an ON voltage to the first and second gate wirings to thereby turn ON the switches of the first and second switching elements, respectively.

(16) In the method according to (11), the display device may further include a third pixel circuit having a third switching element and a third display electrode and arranged along the first pixel circuit, and a fourth pixel circuit having a fourth switching element and a fourth display electrode and arranged along the second pixel circuit; the display control voltage supply unit may supply a display control voltage to the third and fourth display electrodes through the third and fourth switching elements, respectively; when displaying images in a normal scan mode, the method may further include a step wherein in a third write period continuous to the second write period, the display control voltage supply unit turns ON a switch of the third switching element, supplies a display control voltage corresponding to display data of the third pixel circuit to the third display electrode, turns ON a switch of the fourth switching element in synchronization with the time when the switch of the third switching element is turned ON, supplies the display control voltage corresponding to the display data of the third pixel circuit to the fourth display electrode, a step wherein in a fourth write period continuous to the third write period, the display control voltage supply unit maintains the switch of the fourth switching element to be in the ON state, turns OFF the switch of the third switching element, and supplies a display control voltage corresponding to display data of the fourth pixel circuit to the fourth display electrode in synchronization with the time when the switch of the third switching element is turned OFF, and wherein when displaying images in a reverse scan mode where the images are displayed in a reversed manner, the method further comprises, a step wherein in a fifth write period, the display control voltage supply unit turns ON the switch of the third switching element, supplies a display control voltage corresponding to display data of the third pixel circuit to the third display electrode, turns ON the switch of the fourth switching element in synchronization with the time when the switch of the third switching element is turned ON, and supplies the display control voltage corresponding to the display data of the third pixel circuit to the fourth display electrode, a step wherein in a sixth write period continuous to the fifth write period, the display control voltage supply unit maintains the switch of the fourth switching element to be in the ON state, turns off the switch of the third switching element, and supplies a display control voltage corresponding to display data of the fourth pixel circuit to the fourth display electrode in synchronization with the time when the switch of the third switching element is turned OFF, a step wherein in a seventh write period continuous to the sixth write period, the display control voltage supply unit turns ON the switch of the first switching element, supplies a display control voltage corresponding to display data of the first pixel circuit to the first display electrode, turns ON the switch of the second switching element in synchronization with the time when the switch of the first switching element is turned ON, and supplies the display control voltage corresponding to the display data of the first pixel circuit to the second display electrode, and a step wherein in an eighth write period continuous to the seventh write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

(17) In the method according to (16), output sides of the first to fourth switching elements may be connected to the first to fourth display electrodes, respectively; the display control voltage supply unit may further include a data signal wiring connected to each of input sides of the first to fourth switching elements, and in the respective steps, the display control voltage supply unit may apply a display control voltage to the data signal wiring to thereby supply the display control voltage to a display electrode connected to an output side of a switching element being in the ON state among the first to fourth switching elements.

(18) In the method according to (17), the display control voltage supply unit may further include a first gate wiring connected to the switch of the first switching element, a second gate wiring connected to the switch of the second switching element, a third gate wiring connected to the switch of the third switching element, and a fourth gate wiring connected to the switch of the fourth switching element; and in the respective steps, the display control voltage supply unit may apply an ON voltage to the first to fourth gate wirings to thereby turn ON the switches of the first to fourth switching elements, respectively.

(19) In the method according to (11), output sides of the first and second switching elements may be connected to the first and second display electrodes, respectively; and the display control voltage supply unit may further include a data signal wiring connected to each of input sides of the first and second switching elements; and the method may further include a step wherein the display control voltage supply unit supplies a different voltage from a display voltage corresponding to the display data of the first pixel circuit to the data signal line in synchronization with the time when a reference potential serving as the reference of the display control voltage supplied to the first and second pixel electrodes changes to a different potential.

(20) In the method according to (19), the different voltage may be a voltage higher than the display voltage corresponding to the display data of the first pixel circuit when the reference voltage changes from a high voltage to a low voltage and may be a voltage lower than the display voltage corresponding to the display data of the first pixel circuit when the reference voltage changes from a low voltage to a high voltage.

According to the invention, a display device and a method of driving the same, capable of improving display quality by suppressing abnormal changes in the potential of a display electrode resulting from a parasitic capacitance are provided.

### BRIEF DESCRIPTION OF THE DRAWINGS

In the accompanying drawings:

FIG. 1 is a general perspective view of a liquid crystal display device according to an embodiment of the invention;

FIG. 2 is a diagram showing an equivalent circuit of a TFT substrate of the liquid crystal display device according to the embodiment of the invention;

FIG. 3 is a diagram showing a configuration of a display region of the liquid crystal display device according to the embodiment of the invention;

FIG. 4 is a circuit diagram showing a parasitic capacitance in a pixel circuit of the liquid crystal display device according to the embodiment of the invention;

FIG. 5 is a diagram showing a method of driving a liquid crystal display device according to a first embodiment of the invention;

FIG. 6A is a plan view showing an example of the structure of two pixel circuits in the display region of the liquid crystal display device according to the embodiment of the invention;

FIG. 6B is a plan view showing another example of the structure of two pixel circuits in the display region of the liquid crystal display device according to the embodiment of the invention;

FIG. 7A is a cross-sectional view showing an example of the structure of a TFT substrate in the display region of the liquid crystal display device according to the embodiment of the invention;

FIG. 7B is a cross-sectional view showing another example of the structure of the TFT substrate in the display region of the liquid crystal display device according to the embodiment of the invention;

FIG. 8 is a diagram showing part of a method of driving a liquid crystal display device according to a second embodiment of the invention;

FIG. 9A is a diagram showing part of a method of driving a liquid crystal display device according to a third embodiment of the invention;

FIG. 9B is a diagram showing part of the method of driving a liquid crystal display device according to the third embodiment of the invention;

FIG. 9C is a diagram showing part of a method of driving a liquid crystal display device according to a fourth embodiment of the invention;

FIG. 9D is a diagram showing part of the method of driving a liquid crystal display device according to the fourth embodiment of the invention;

FIG. 10A is a diagram showing a method of driving a liquid crystal display device according to a fifth embodiment of the invention;

FIG. 10B is a diagram showing a method of driving a liquid crystal display device according to the related art of the invention;

FIG. 11 is a diagram showing an equivalent circuit of a TFT substrate of a liquid crystal display device according to another embodiment of the invention;

FIG. 12 is a circuit diagram showing the control of a display panel of the liquid crystal display device according to the related art; and

FIG. 13 is a diagram showing a method of driving the liquid crystal display device according to the related art.

### DETAILED DESCRIPTION OF THE INVENTION

Hereinafter, a display device and a method of driving the same according to the embodiments of the invention will be described in detail. The drawings below are just used for showing the examples of the respective embodiments, and the sizes shown in the drawings are not necessarily identical to the dimensions described in the specification.

### First Embodiment

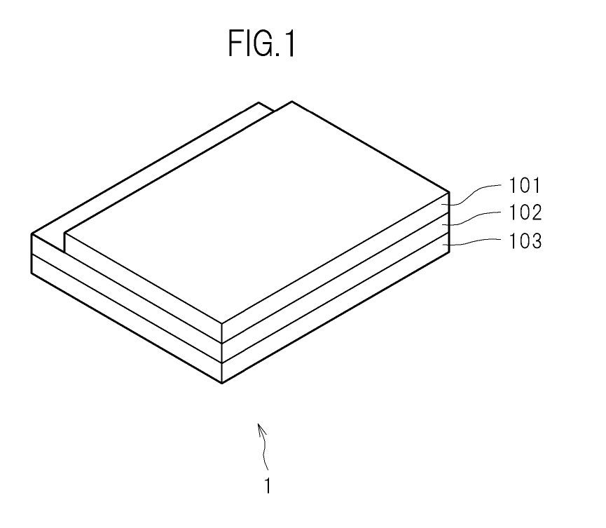

A display device according to a first embodiment of the invention is a liquid crystal display device 1 according to one of IPS (In-Plane Switching) liquid crystal display devices. FIG. 1 is a general perspective view of the liquid crystal display device 1 according to this embodiment of the invention. As shown in FIG. 1, the liquid crystal display device 1 includes a TFT substrate 102 in which thin film transistors (hereinafter referred to as TFTs) are arranged on a transparent substrate such as a glass substrate, a filter substrate 101 which faces the TFT substrate 102 and has color filters formed thereon, a liquid crystal material filled in a region sandwiched between the two substrates 102 and 101, a backlight 103 disposed on a side of the TFT substrate 102 opposite the filter substrate 101, and a flexible substrate (not shown) supplying various control signals and the like to the TFT substrate 102. Here, the TFT is a transistor including a thin-film layer formed of amorphous silicon and is one of switching elements.

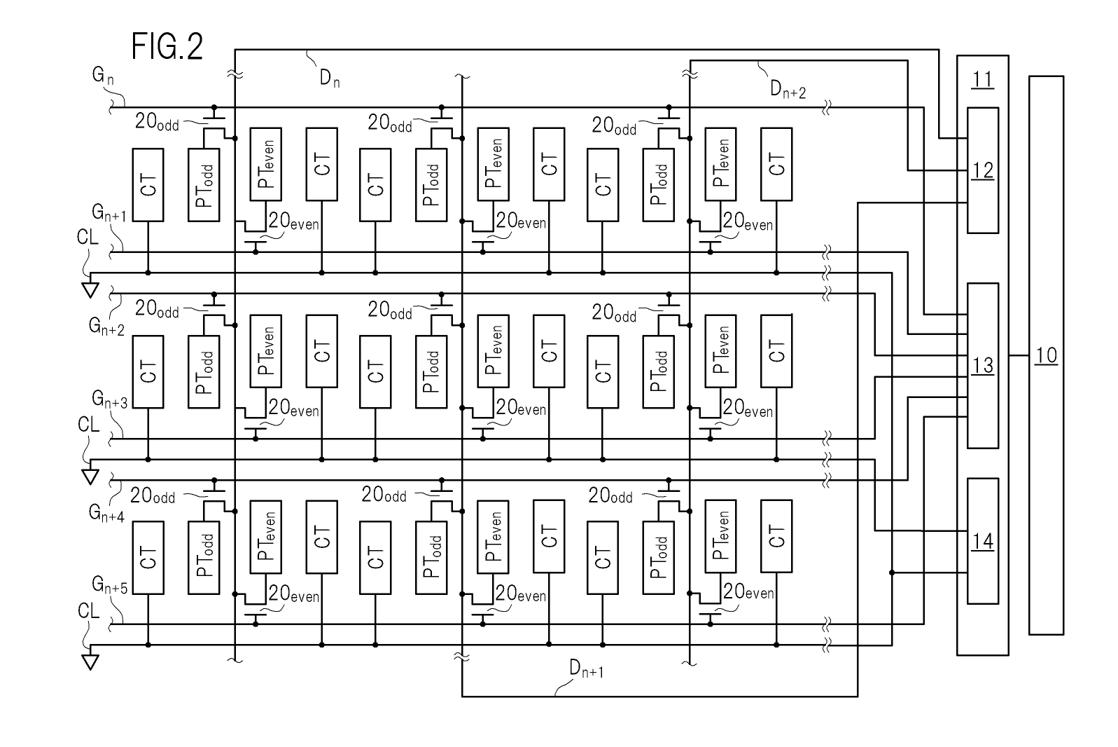

FIG. 2 is an equivalent circuit of the TFT substrate 102 of the liquid crystal display device 1 according to this embodiment.

A connector 10 for connection to the flexible substrate is shown on the right side of FIG. 2, and as described above, various control signals necessary for image display are supplied through the connector 10 to the TFT substrate 102 from the flexible substrate. The TFT substrate 102 includes a control circuit 11, and the control signals are input to the control circuit 11 from the flexible substrate. The control circuit 11 is a controller driver IC integrated in one chip, for example, and includes a data signal driving circuit 12, a scanning signal driving circuit 13, a reference voltage supply circuit 14, and the like. Moreover, the TFT substrate 102 has a plurality of pixel circuits which are arranged regularly, and each of the pixel circuits includes a TFT 20 serving as a switching element, a pixel electrode PT serving as a display electrode, a common electrode CT to which a reference potential is supplied, and the like.

A plurality of data signal lines (data signal wirings), a plurality of scanning signal lines (gate wirings), and a plurality of reference voltage lines CL are respectively extended from the data signal driving circuit 12, the scanning signal driving circuit 13, and the reference voltage supply circuit 14 provided in the control circuit 11 over the plurality of pixel circuits provided in the display region of the TFT substrate 102.

As shown in FIG. 2, two scanning signal lines are arranged for a plurality of pixel circuits arranged on one row in the horizontal direction of the figure, and the two scanning signal lines are alternately connected to the gate electrodes of the TFTs 20 of the plurality of pixel circuits arranged on one row in the horizontal direction of the figure. Moreover, the data signal lines are arranged every two pixel circuits of the plurality of pixel circuits arranged on one row in the horizontal direction of the figure, and the data signal lines are connected to input sides of the TFTs 20 of two pixel circuits disposed on both sides of each of the data signal lines. Output sides of the TFTs 20 are connected to the pixel electrodes PT. Here, the gate electrodes of the TFTs 20 function as the switches of the switching elements. Moreover, in the following description, for the sake of convenience, the electrodes on the input sides of the TFTs 20 connected to the data signal lines will be referred to as drain electrodes, and the electrodes on the output sides of the TFTs 20 connected to the pixel electrode PT will be referred to as source electrodes.

As shown in FIG. 2, two scanning signal lines G_{˜} and Gₙ₊₁ are arranged for a plurality of pixel circuits arranged on the first row from the top of the figure, two scanning signal lines Gₙ₊₂ and Gₙ₊₃ are arranged for a plurality of pixel circuits arranged on the second row from the top of the figure, and two scanning signal lines Gₙ₊₄ and Gₙ₊₅ are arranged for a plurality of pixel circuits arranged on the third row from the top of the figure. Moreover, the scanning signal lines will be collectively referred to as a scanning signal line Gₙ.

As shown in FIG. 2, partial data signal lines of the plurality of data signal lines are extended from the data signal driving circuit 12 disposed on the right side of the figure to the corresponding pixel circuits in a downward direction of the figure from the upper end of the display region through a frame region of the display region on the upper side of the figure. In FIG. 2, data signal lines Dₙ and Dₙ₊₂ among the partial data signal lines are shown. The other data signal lines are extended to the corresponding pixel circuits in the upward direction of the figure from the lower end of the display region through a frame region of the display region on the lower side of the figure. In FIG. 2, a data signal line Dₙ₊₁ among the other data signal lines is shown. Moreover, the data signal lines will be collectively referred to as a data signal line Dₙ.

Furthermore, on the lower side of the figure, one reference voltage line CL is arranged for the plurality of pixel circuits arranged on one row in the horizontal direction of the figure, and the one reference voltage line CL is connected to the common electrodes CT of the plurality of pixel circuits arranged on one row in the horizontal direction of the figure.

Here, a display control voltage supply unit includes the control circuit 11 which includes the data signal driving circuit 12, the scanning signal driving circuit 13, the reference voltage supply circuit 14, and the like, the plurality of scanning signal lines Gₙ, the plurality of data signal lines Dₙ, and the plurality of reference voltage lines CL.

Scanning signal lines disposed on the upper side of the plurality of pixel circuits of each row shown in the figure will be referred to as odd scanning signal lines, and scanning signal lines disposed on the lower side will be referred to as even scanning signal lines. Moreover, pixel circuits connected to the odd scanning signal lines, and the TFTs 20 and the pixel electrodes PT formed in these pixel circuits will be referred to as odd pixel circuits, odd TFTs 20_{odd}, and odd pixel electrodes PT_{odd}, respectively. Furthermore, pixel circuits connected to the even scanning signal lines and the TFTs 20 and the pixel electrodes PT formed in these pixel circuits will be referred to as even pixel circuits, even TFTs 20ₑᵥₑₙ, and even pixel electrodes PTₑᵥₑₙ, respectively.

The data signal lines Dₙ are connected to the drain electrodes of the TFTs 20 of two pixel circuit disposed on both sides of each of the data signal lines Dₙ among the plurality of pixel circuits arranged on each row, and are extended in the vertical direction of the figure. Moreover, the plurality of pixel circuits arranged on each row are arranged as an odd pixel circuit, an even pixel circuit, and an odd pixel circuit in that order from the left to right.

In the circuit configuration described above, the reference voltage supply circuit 14 supplies reference potentials to the common electrodes CT of the respective pixel circuits through the reference voltage lines CL. gate voltages are applied to the scanning signal lines Gₙ and currents passing through the TFTs 20 are controlled. Specifically, the control is performed in the following manner. The scanning signal driving circuit 13 applies HIGH voltage to the scanning signal line Gₙ for a predetermined period, whereby HIGH voltage serving as ON voltage is applied to the gate electrodes of the TFTs 20 connected to the scanning signal line Gₙ. The TFTs 20 to which ON voltage is applied are turned ON, and during the ON period of the TFTs 20, display control voltages corresponding to the display data of the pixel circuits having the TFTs 20 is applied to the corresponding data signal lines Dₙ from the data signal driving circuit 12. In this way, the display control voltages is supplied to the pairs of the pixel electrodes PT and the common electrodes CT of the pixel circuits through the TFTs 20 connected to the scanning signal line Gₙ. After the elapse of the predetermined period, the scanning signal driving circuit 13 applies LOW voltage to the scanning signal line Gₙ, whereby LOW voltage serving as OFF voltage is applied to the gate electrodes of the TFTs 20 connected to the scanning signal line Gₙ. The TFTs 20 to which the OFF voltage is applied are turned OFF. The display control voltages between the pixel electrodes PT and the common electrodes CT are maintained even after the TFTs 20 are turned OFF. In this way, the alignment or the like of the liquid crystal molecules provided in the pixel circuits is controlled, and images are displayed.

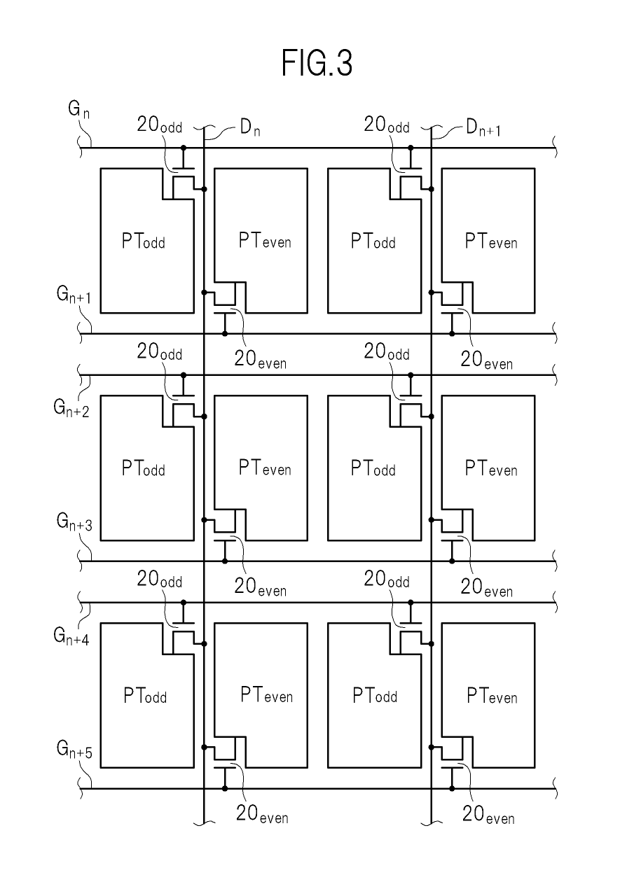

FIG. 3 is a diagram showing a configuration of the display region of the liquid crystal display device 1 according to this embodiment. A plurality of pixel circuits are arranged in the display region of the display panel. As described above, each of the pixel circuits includes the TFT 20, the pixel electrode PT, and the common electrode CT (not shown). As will be described later, the pixel electrodes PT provided in the respective pixel circuits are formed in the same layer. Moreover, a parasitic capacitance exists between two pixel electrodes PT. The parasitic capacitance existing between the two pixel electrodes PT depends on the distance between the pixel electrodes PT. Therefore, since the distance between two adjacent pixel electrodes PT is shorter than the others, the parasitic capacitance between the two adjacent pixel electrodes PT is larger than the parasitic capacitance between the other two pixel electrodes PT.

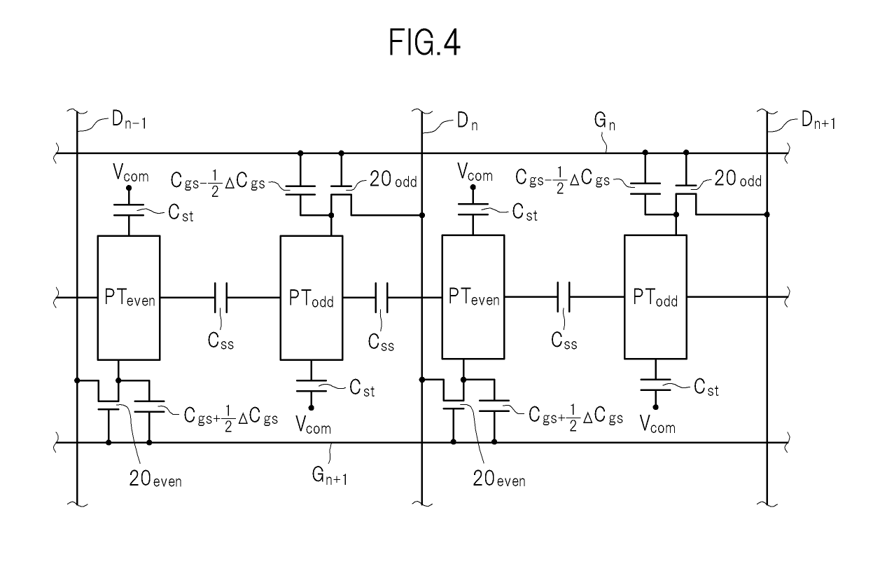

FIG. 4 is a circuit diagram showing a parasitic capacitance in the pixel circuit of the liquid crystal display device 1 according to this embodiment. The gate electrode and the source electrode of the TFT 20 overlap with each other in plan view through a gate insulating film and a silicon semiconductor film, and a parasitic capacitance C_{gs} exists between the gate electrode and the source electrode of the TFT 20. Similarly, a parasitic capacitance Cₛₛ exists between two adjacent pixel electrodes PT.

The parasitic capacitance C_{gs} existing between the gate electrode and the source electrode of the TFT 20 depends on an area of the region where the gate electrode facing the source electrode. When a positional deviation occurs in forming of the gate electrodes or the source electrodes, the area of the region where the gate electrode facing the source electrode may appear as a systematic error between the odd TFTs 20_{odd} and the even TFTs 20ₑᵥₑₙ. In FIG. 4, using ΔC_{gs} as the systematic error of the parasitic capacitance C_{gs}, the parasitic capacitance C_{gs} of the odd TFT 20_{odd} is denoted more accurately as C_{gs}−(1/2)ΔC_{gs}, and the parasitic capacitance C_{gs} of the even TFT 20ₑᵥₑₙ is denoted more accurately as C_{gs}+(1/2)ΔC_{gs}.

As described above, a parasitic capacitance exists between two pixel electrodes PT, and particularly, the parasitic capacitance between two adjacent pixel electrodes PT is much larger than the others. In addition, the distance between two pixel electrodes PT arranged on one row in the horizontal direction of the figure among a plurality of groups of two adjacent pixel electrodes PT shown in FIG. 3 is shorter than the distance between two pixel electrodes PT each positioned on the adjacent rows and arranged in the vertical direction of the figure. Therefore, in FIG. 4, the parasitic capacitance between two pixel electrodes PT arranged to be adjacent to each other in the horizontal direction of the figure is shown and denoted as a parasitic capacitance Cₛₛ.

As described above, the display control voltage is supplied from the data signal line Dₙ to the pair of the pixel electrode PT and the common electrode CT in accordance with the display data of the pixel circuit, and the display control voltage is maintained thereafter. That is, a capacitance is also formed between the pixel electrode PT and the common electrode CT, and is denoted as a capacitance Cₛₜ in FIG. 4. The potential of the common electrode CT is used as a reference potential V_{com}.

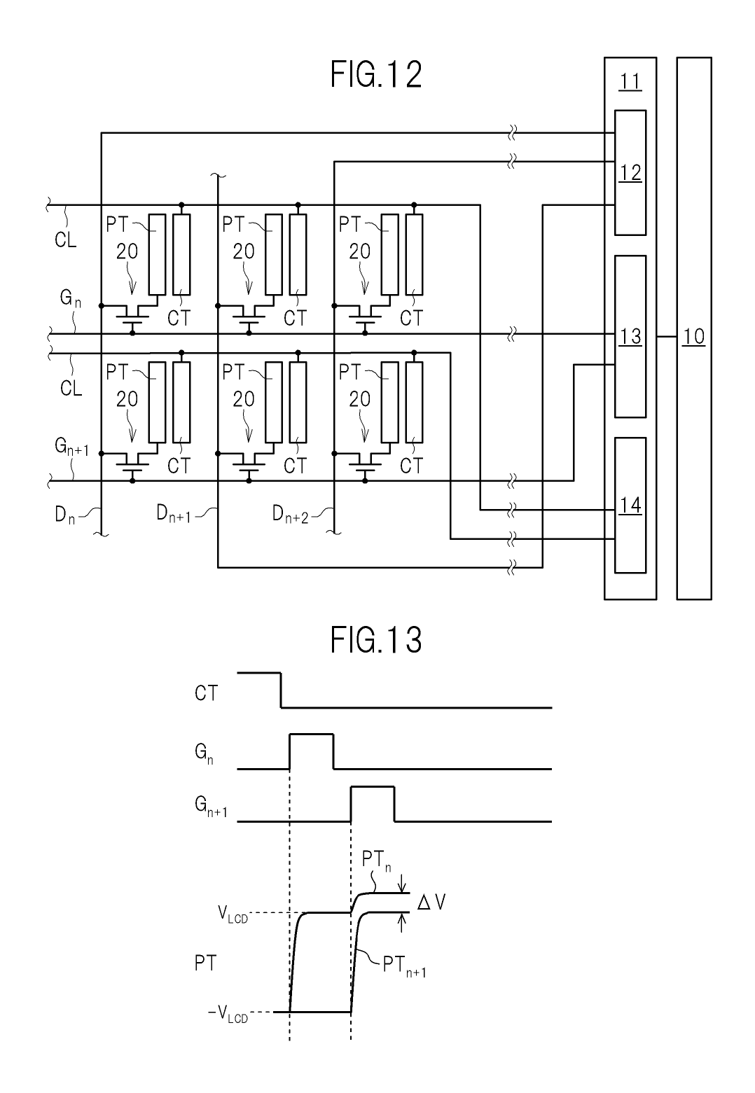

By these parasitic capacitances C_{gs}, Cₛₛ, and the like affect the display control voltage maintained (in the capacitance Cₛₜ) between the pixel electrode PT and the common electrode CT. Unlike the parasitic capacitance C_{gs} existing between the gate electrode and the source electrode of the TFT 20, the parasitic capacitance between two pixel electrodes PT, particularly the parasitic capacitance Cₛₛ between the two adjacent pixel electrodes PT causes abnormalities in the display control voltage supplied to the pair of the pixel electrode PT and the common electrode CT when driven by the driving method shown in FIG. 13. Thus, display abnormalities are caused.

The invention provides a driving method capable of suppressing abnormal changes in the potential of the display electrode resulting from the parasitic capacitance between two display electrodes.

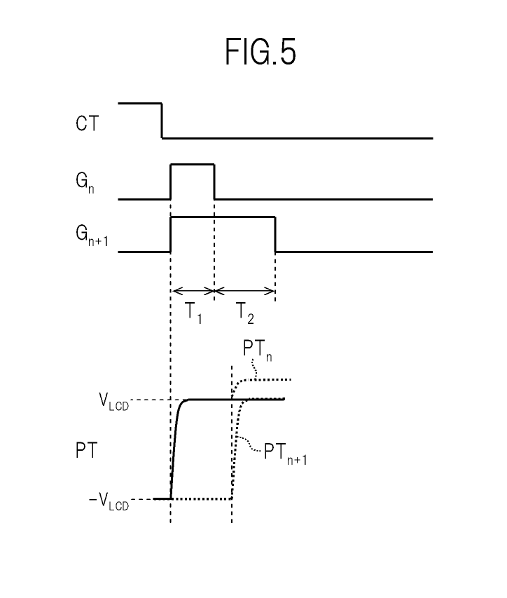

FIG. 5 is a diagram showing a method of driving the liquid crystal display device 1 according to this embodiment. FIG. 5 shows two pixel circuits provided in the liquid crystal display device 1 according to this embodiment.

The two pixel circuits are first and second pixel circuits. The first pixel circuit is a pixel circuit that is on the first row from the top of FIGS. 2 and 3, for example, and appears in the first place from the left. The second pixel circuit is a pixel circuit that is on the first row from the top of the figures, for example, and appears in the second place from the left. The pixel circuit appearing in the first place from the left side of the figures is an odd pixel circuit and includes an odd TFT 20_{odd} which is a first switching element and an odd pixel electrode PT_{odd} which is a first display electrode. The odd TFT 20_{odd} and the odd pixel electrode PT_{odd} will be referred to as a TFT 20ₙ and a pixel electrode PTₙ, respectively. Similarly, the pixel circuit appearing in the second place from the left side of the figures is an even pixel circuit and includes an even TFT 20ₑᵥₑₙ which is a second switching element and an even pixel electrode PTₑᵥₑₙ which is a second display electrode. The even TFT 20ₑᵥₑₙ and the even pixel electrode PTₑᵥₑₙ will be referred to as a TFT 20ₙ₋₁ and a pixel electrode PTₙ₊₁, respectively.

As shown in FIGS. 2 and 3, the scanning signal line Gₙ which is a first gate wiring is connected to the gate electrode of the TFT 20ₙ, and the scanning signal line Gₙ₊₁ which is a second gate wiring is connected to the gate electrode of the TFT 20ₙ₋₁.

As shown in FIGS. 2 and 3, the data signal line Dₙ which is the data signal wiring is connected to the drain electrodes of the TFTs 20ₙ and 20ₙ₊₁.

In FIG. 5, the changes over time of the respective potentials of the common electrode CT, the scanning signal line Gₙ, the scanning signal line Gₙ₊₁, and the pixel electrode PT are shown in that order from the top similarly to FIG. 13. In the potentials of the pixel electrodes PT, the potential of the pixel electrode PTₙ and the potential of the pixel electrode PTₙ₊₁ are superimposed. Moreover, two curves indicated by the broken line in relation to the pixel electrode PT of FIG. 5 are the potentials of the pixel electrodes PTₙ and PTₙ₊₁ when driven by the driving method according to the related art shown in FIG. 13 and are shown for comparison with the related art.

In FIG. 5, for the sake of simplicity, a case in which the display data of the two pixel circuits are the same, and the display control voltages to be supplied to the pixel electrodes PTₙ and PTₙ₋₁ are the same is shown similarly to FIG. 13.

As described above, the reference voltage supply circuit 14 supplies the reference potential to the common electrodes CT of the two pixel circuits through the reference voltage line CL. In the liquid crystal display device 1 according to this embodiment, the reference potential is driven by an AC driving method in which two potentials of a high potential (hereinafter referred to as a positive potential) and a low potential (hereinafter referred to as a negative potential) are periodically and alternately repeated.

The AC driving method mainly includes a line inversion driving method and a frame inversion driving method. In the liquid crystal display device 1 according to this embodiment, the reference potential is driven by the line inversion driving method. The invention can be applied to other inversion driving methods as well as the frame inversion driving method as long as the same reference potentials are supplied to two pixel circuits.

Here, the frame inversion driving method is a driving method in which the reference potentials supplied to the common electrodes of a plurality of pixel circuits present in the display region of a display device are the same and change together. Moreover, the reference potential is driven such that two potentials of positive potential and negative potential are periodically and alternately repeated.

On the other hand, the line inversion driving method is a driving method in which the reference potentials supplied to the common electrodes of a plurality of pixel circuits arranged on each row among a plurality of pixel circuits present in the display region of a display device are the same, and the reference potentials supplied to the common electrodes of a plurality of pixel circuits arranged on two adjacent rows are different from each other. That is, if the reference potentials of a plurality of pixel circuits arranged on a certain row are positive potentials, the reference potentials of a plurality of pixel circuits arranged on the adjacent rows are negative potentials. Moreover, the reference potentials are driven such that two potentials of positive potential and negative potential are periodically and alternately repeated. That is, the changes over time of the reference potential of a plurality of pixel circuits arranged on a certain row have an inverse phase relationship from those of the reference potential of a plurality of pixel circuits arranged on the adjacent rows.

In FIG. 5, the potential of the common electrode CT changes from positive potential to negative potential due to line inversion driving. As described above, the two pixel circuits are arranged on one row in the horizontal direction of FIGS. 2 and 3, and the reference potentials supplied to the two pixel circuits are the same and change together.

In synchronization with the time when the potential of the common electrode CT changes from positive potential to negative potential, HIGH voltage is applied to the two scanning signal lines Gₙ and Gₙ₊₁, by the scanning signal driving circuit 13 in a first write period, and accordingly, HIGH voltage is applied to the gate electrodes of two TFTs 20ₙ and 20ₙ₊₁, and the two TFTs 20ₙ and 20ₙ₋₁ are turned ON together. Here, the first write period means a period when the scanning signal line Gₙ is at HIGH voltage. In FIG. 5, the first write period is denoted as T₁, and the scanning signal line Gₙ₊₁ is also at HIGH voltage over the entire first write period.

In the first write period, a display control voltage corresponding to the display data of the first pixel circuit is applied to the data signal line Dₙ from the data signal driving circuit 12 in synchronization with the time when the scanning signal line Gₙ changes to HIGH voltage, namely the time when the TFT 20ₙ is turned ON. In the first write period, the two TFTs 20ₙ and 20ₙ₋₁ are in the ON state, and the display control voltage applied to the data signal line Dₙ is supplied to the two pixel electrodes PTₙ and PTₙ₊₁ through the two TFTs 20ₙ and 20ₙ₊₁, respectively. Here, supplying the display control voltage to the pixel electrode PT means supplying the display control voltage to the pair of the pixel electrode PT and the common electrode CT which has the reference potential.

In the first write period, the potentials of the two pixel electrodes PTₙ and PTₙ₋₁ rise from −V_{LCD} and then smoothly converge to V_{LCD} as shown in FIG. 5.

In a second write period continuous to the first write period, the scanning signal driving circuit 13 applies LOW voltage to the scanning signal line Gₙ, and HIGH voltage is maintained in the scanning signal line Gₙ₊₁. In this way, LOW voltage is applied to the gate electrode of the TFT 20ₙ, and HIGH voltage is maintained in the gate electrode of the TFT 20ₙ₊₁. Thus, the TFT 20ₙ is turned OFF, and the TFT 20ₙ₋₁ is maintained in the ON state. Here, the second write period means a period which starts when the scanning signal line Gₙ changes to LOW voltage and ends when the scanning signal line Gₙ₊₁ changes to LOW voltage. Only the scanning signal line Gₙ₋₁ among the two scanning signal lines Gₙ and Gₙ₊₁ is at HIGH voltage over the entire second write period. In FIG. 5, the second write period is denoted as T₂.

In the second write period, a display control voltage corresponding to the display data of the second pixel circuit is applied to the data signal line Dₙ from the data signal driving circuit 12 in synchronization with the time when the scanning signal line Gₙ changes to LOW voltage, namely the time when the TFT 20ₙ is turned OFF. In the second write period, the TFT 20ₙ is in the OFF state and the TFT 20ₙ₊₁ is in the ON state, and the display control voltage applied to the data signal line Dₙ is supplied to the pixel electrode PTₙ₊₁ through the TFT 20ₙ₊₁.

In the second write period, the potential of the pixel electrode PTₙ₊₁ changes from the display control voltage corresponding to the display data of the first pixel circuit to the display control voltage corresponding to the display data of the second pixel circuit. However, since FIG. 5 shows the case in which the display data of the two pixel circuits are the same, and the display control voltages to be supplied to the pixel electrodes PTₙ and PTₙ₊₁ are the same, the potential of the pixel electrode PTₙ₊₁ does not change.

As described above, since the parasitic capacitance Cₛₛ exists between the pixel electrode PTₙ and the pixel electrode PTₙ₊₁, capacitive coupling takes place between the pixel electrode PTₙ and the pixel electrode PTₙ₊₁. However, despite the capacitive coupling, since the potential of the pixel electrode PTₙ₊₁ does not change in the second write period, a part of the display control voltage supplied to the pair of the pixel electrode PTₙ₋₁ and the common electrode CT is not added to the display control voltage maintained between the pixel electrode PTₙ and the common electrode CT. Therefore, unlike the driving method according to the related art shown in FIG. 13, the potential of the pixel electrode PTₙ shown in FIG. 5 does not change in the second write period and is maintained to be constant.

When the liquid crystal display device 1 according to this embodiment is driven by the driving method according to the related art shown in FIG. 13, an abnormal voltage change of ΔV occurs in the potential of the pixel electrode PTₙ. In contrast, when the liquid crystal display device 1 according to this embodiment is driven by the driving method according to this embodiment shown in FIG. 5, the abnormal change occurring in the potential of the pixel electrode PT_{˜} is suppressed.

In the description above, only the parasitic capacitance Cₛₛ existing between the pixel electrode PTₙ of the first pixel circuit and the pixel electrode PTₙ₊₁ of the second pixel circuit has been considered. However, actually, as shown in FIG. 4, even pixel electrodes PTₑᵥₑₙ are disposed on both sides of the odd pixel electrode PT_{odd}, and the parasitic capacitances Cₛₛ also exist between the odd pixel electrode PT_{odd} and the respective even pixel electrodes PTₑᵥₑₙ.

Two scanning signal lines are connected to a plurality of pixel circuits arranged on one row in the horizontal direction of FIGS. 2 and 3, and one data signal line is connected to every two pixel circuits among the plurality of pixel circuits. In the driving method according to the related art shown in FIG. 13, first, the scanning signal line Gₙ changes to HIGH voltage, display control voltages corresponding to the respective display data are supplied to a plurality of odd pixel circuits including the first pixel circuit among the plurality of pixel circuits arranged on one row in the horizontal direction, and the potentials of a plurality of odd pixel electrodes PT_{odd} including the pixel electrode PTₙ are changed. After that, the scanning signal line Gₙ changes to LOW voltage and the scanning signal line Gₙ₊₁ changes to HIGH voltage, display control voltages corresponding to the respective display data are supplied to a plurality of even pixel circuits including the second pixel circuit, and the potentials of the even pixel electrodes PTₑᵥₑₙ including the pixel electrode PTₙ₊₁ are changed. At this time, when the potentials of the even pixel electrodes PTₑᵥₑₙ are changed, an abnormal change occurs in the potentials of the odd pixel electrodes PT_{odd} mainly due to the capacitive coupling with the even pixel electrodes PTₑᵥₑₙ positioned on both sides of the odd pixel electrodes PT_{odd}. That is, in the case of the first pixel circuit, since capacitive coupling takes place between the pixel electrode PTₙ and an even pixel electrode PTₑᵥₑₙ positioned on the side opposite to the pixel electrode PTₙ₊₁ as well as between the pixel electrode PTₙ and the pixel electrode PTₙ₊₁, an abnormal voltage change of ΔV occurs in the potential of the pixel electrode PTₙ due to the capacitive coupling. This voltage ΔV is approximated as ΔV=4×(Cₛₛ/Cₛₜ)×V_{LCD}. In contrast, in the driving method according to this embodiment, it is possible to suppress the potential of the pixel electrode provided in the first pixel circuit from being changed due to the parasitic capacitances existing between the pixel electrode of the first pixel circuit and the pixel electrodes provided in the pixel circuits positioned on both sides of the first pixel circuit.

Although FIG. 5 shows the case in which the display data of the first and second pixel circuits are the same for the sake of simplicity, the invention can be also applied to a case in which the display data of the first and second pixel circuits are different. That is, in the first write period, the potential of the pixel electrode PTₙ₊₁ in response to the reference potential changes to the display control voltage corresponding to the display data of the first pixel circuit. Thus, even when a display voltage corresponding to the display data of the second pixel circuit is supplied to the pixel electrode PTₙ₊₁ in the second write period, the change in the potential of the pixel electrode PTₙ₊₁ in the second write period corresponds to only the voltage difference between the display control voltage corresponding to the display data of the first pixel circuit and the display control voltage corresponding to the display data of the second pixel circuit. Thus, the change in the potential is suppressed as compared to the case of the driving method according to the related art. Although in the second write period, an abnormal change occurs in the potential of the pixel electrode PTₙ in accordance with the change in the potential of the pixel electrode PTₙ₊₁, since the change in the potential of the pixel electrode PTₙ₊₁ is suppressed, the abnormal change occurring in the potential of the pixel electrode PTₙ is also suppressed.

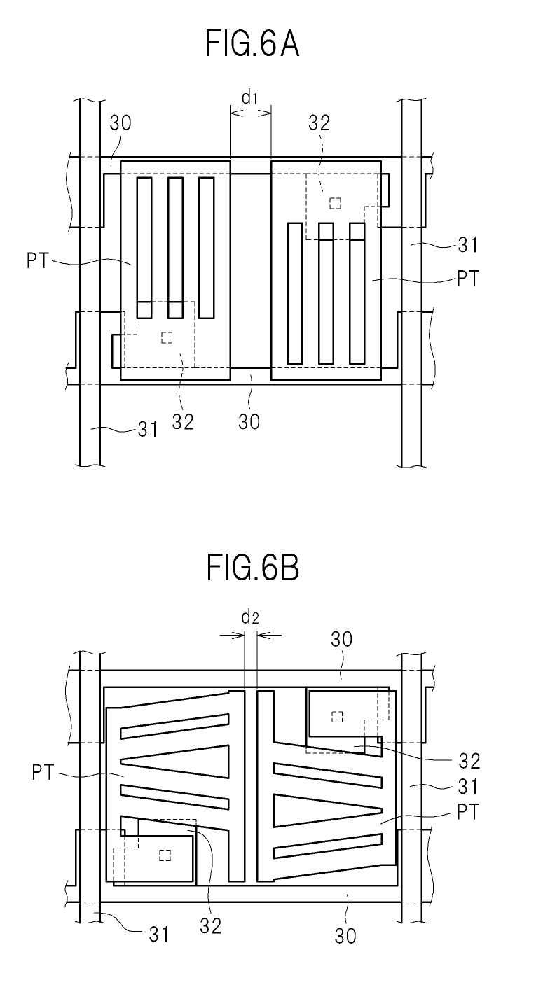

FIG. 6A is a plan view showing an example of the structure of two pixel circuits in the display region of the liquid crystal display device 1 according to this embodiment. The two pixel circuits shown in FIG. 6A have a source-top IPS structure as will be described later, and the pixel electrodes PT have a single domain structure. FIG. 6A shows the two pixel circuits which appears in the second and third places from the left side of the first row from the top of FIGS. 2 and 3, for example.

As shown in FIG. 6A, the scanning signal line and the gate electrode of the TFT 20 are actually formed in the same film, and this film will be referred to as a gate electrode film 30. The gate electrode film 30 has portions extending in the horizontal direction of the figure and portions protruding in the lateral direction. A rectangular region in the gate electrode film 30, formed by including the portions protruding in the lateral direction and the portion positioned on the lower side of the figure and extending from the portions in the horizontal direction of the figure is the gate electrode of the TFT 20. A portion of the gate electrode film 30, which is part of the portions extending in the horizontal direction of the figure and which does not belong to the gate electrode of the TFT 20 is the scanning signal line.

A gate insulating film 41 (not shown) is formed on the entire upper surface of the gate electrode film 30, and a silicon semiconductor film 36 (not shown) is formed in a portion of the gate insulating film 41 disposed above a region corresponding to the gate electrode of the TFT 20. A drain electrode film 31 and a source electrode film 32 are formed above the silicon semiconductor film 36 with an impurity silicon semiconductor film (not shown) disposed therebetween. Although in this example, the silicon semiconductor film 36 is formed of amorphous silicon, the silicon semiconductor film 36 may be formed of polysilicon or microcrystalline silicon.

In FIGS. 2 and 3, the data signal line is connected to the drain electrodes of the TFTs 20 of the pixel circuits positioned on the lateral side of the data signal line. However, as shown in FIG. 6A, the drain electrode of the TFT 20 and the data signal line are actually formed on the drain electrode film 31.

The drain electrode film 31 shown in FIG. 6A extends in the vertical direction of the figure and overlaps with the gate electrode film 30 in plan view. A portion of the drain electrode film 31 overlapping with the region corresponding to the gate electrode of the gate electrode film 30 in plan view is the drain electrode of the TFT 20, and the other portion is the data signal line.

Although FIG. 6A shows an example in which the drain electrode film 31 has a shape such that it extends in the vertical direction of the figure, the drain electrode film may have a shape, for example, such that it includes the portion extending in the vertical direction of the figure and portions protruding in the lateral direction similarly to the gate electrode film 30.

As shown in FIG. 6A, the source electrode film 32 has the drain electrode of the TFT 20 overlapping with the gate electrode film 30 in plan view and a contact portion widening in the horizontal direction of the figure.

An insulating film 43 (not shown), a common electrode CT (not shown), and an insulating film 44 (not shown) are formed above the drain electrode film 31 and the source electrode film 32, and they will be described later. Moreover, a pixel electrode PT is formed above the insulating film 43 so as to cover the source electrode film 32. A contact hole 35 (not shown) is formed in a portion of the insulating films 43 and 44 positioned above the contact portion of the source electrode film 32, and the pixel electrode PT is electrically connected to the source electrode film 32 through the contact hole 35. In FIG. 6A, bonding portions between the pixel electrode PT and the source electrode film 32 are shown as squares which are surrounded by broken lines and disposed on the contact portion of the source electrode film 32. Such a structure is referred to as a source-top IPS structure among the IPS liquid crystal display devices since the pixel electrode PT connected to the source electrode is disposed on the upper side of the TFT substrate 102 than the common electrode CT.

As shown in FIG. 6A, the pixel electrode PT has a rectangular shape, and slits in which no pixel electrode PT is formed are arranged in the horizontal direction of the figure. FIG. 6A shows three rectangular slits extending in the vertical direction of the figure. When images are displayed, a display control voltage is maintained between the pixel electrode PT and the common electrode CT, and an electric field is applied to a liquid crystal material. Due to the slits shown in FIG. 6A, the electric field applied to the liquid crystal material has a component that is parallel to the plane shown in FIG. 6A. The three slits have a rectangular shape extending in the vertical direction of the figure, and the component that is parallel to the plane of the electric field applied to the liquid crystal material is mainly just the component in the horizontal direction of the figure. Therefore, the pixel electrode PT is referred to as a single domain structure. In FIG. 6A, two pixel electrodes PT are shown, and the distance between the two pixel electrodes PT is denoted as d₁.

FIG. 6B is a plan view showing another example of the structure of two pixel circuits in the display region of the liquid crystal display device 1 according to this embodiment. The two pixel circuits shown in FIG. 6B have also a source-top IPS structure, and the pixel electrodes PT have a multi-domain structure as will be described later. Similarly to FIG. 6A, FIG. 6B shows the two pixel circuits which appears in the second and third places from the left side of the first row from the top of FIGS. 2 and 3, for example.

The two pixel circuits shown in FIG. 6B have the same basic structure as the two pixel circuits shown in FIG. 6A and have the source-top IPS structure. The main difference between the structure of the two pixel circuits shown in FIG. 6B and the structure of the two pixel circuits shown in FIG. 6A lies in the shape of the pixel electrodes PT.

Although the pixel electrode PT shown in FIG. 6B has a rectangular shape similarly to the pixel electrode PT shown in FIG. 6A, the shape of slits disposed within the rectangle is different. FIG. 6B shows three slits, and the three slits are made up of an equilateral triangle which is at the center of the figure and extends in the horizontal direction of the figure, and parallelograms which are disposed above and below the equilateral triangle in the vertical direction of the figure and extend in parallel to the oblique sides of the equilateral triangle.

As described above, the electric field applied to the liquid crystal material has a component that is parallel to the plane shown in FIG. 6B. However, unlike the three slits shown in FIG. 6A, the component that is parallel to the plane of the electric field applied to the liquid crystal material mainly includes two components in the two directions perpendicular to the oblique sides of the equilateral triangle due to the shape of the three slits shown in FIG. 6B. Since the component parallel to the plane of the electric field has components of plural directions, the pixel electrode PT is referred to as a multi-domain structure. In FIG. 6B, two pixel electrodes PT are shown, and the distance between the two pixel electrodes PT is denoted as d₂.

Since the slit structure of the pixel electrode PT having the multi-domain structure is generally complex as compared to the pixel electrode PT having the single domain structure, it is necessary to increase the outer edge of the pixel electrode PT. Thus, the distance between two pixel electrodes PT generally decreases. For example, the distance d₂ between the two pixel electrodes shown in FIG. 6B is shorter than the distance d₁ between the two pixel electrodes shown in FIG. 6A.

As described above, the parasitic capacitance existing between two pixel electrodes PT depends on the distance between the two pixel electrodes PT, and the shorter the distance, the larger the parasitic capacitance. Therefore, the parasitic capacitance Cₛₛ between the two pixel electrodes PT shown in FIG. 6B is larger than the parasitic capacitance Cₛₛ between the two pixel electrodes PT shown in FIG. 6A.

Therefore, the abnormal change occurring in the potential of the pixel electrode PT when the pixel electrodes PT of the liquid crystal display device 1 have the shape shown in FIG. 6B is larger than that when the pixel electrodes PT have the shape shown in FIG. 6A. Accordingly, the effects of the invention are more remarkable when the pixel electrodes PT of the liquid crystal display device 1 have the shape shown in FIG. 6B, namely a multi-domain structure.

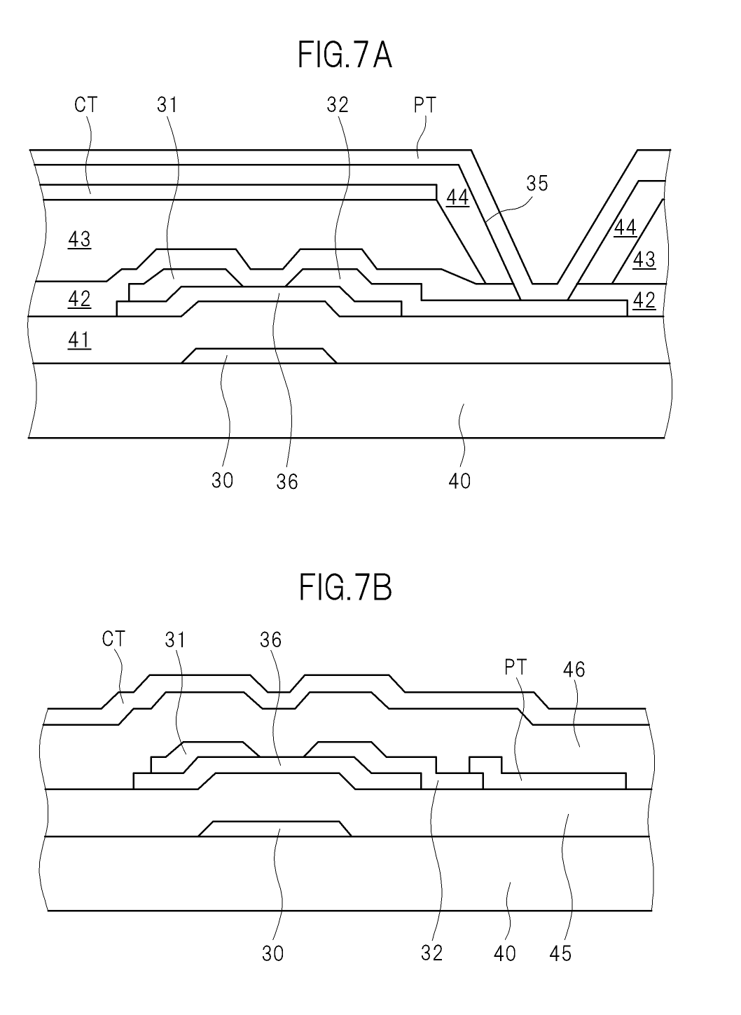

FIG. 7A is a cross-sectional view showing an example of the structure of the TFT substrate 102 in the display region of the liquid crystal display device 1 according to this embodiment. The TFT substrate 102 shown in FIG. 7A has a source-top IPS structure.

A contamination prevention film (not shown) is formed on a transparent substrate 40 such as a glass substrate, and as described above, the gate electrode film 30, the gate insulating film 41, and the silicon semiconductor film 36 are sequentially formed thereon. Moreover, the drain electrode film 31 and the source electrode film 32 are formed on the silicon semiconductor film 36. The insulating film 43 is formed above the drain electrode film 31 and the source electrode film 32, and the common electrode CT is formed thereon excluding the upper portion of the source electrode film 32 near the contact portion. In addition, the insulating film 44 is formed above the common electrode CT, and the portion of the insulating films 43 and 44 positioned above the contact portion of the source electrode film 32 is removed to form the contact hole 35. Moreover, the pixel electrode PT is formed thereon, and the pixel electrode PT is electrically connected to the source electrode film 32 through the contact hole 35.

FIG. 7B is a cross-sectional view showing another example of the structure of the TFT substrate 102 in the display region of the liquid crystal display device 1 according to this embodiment. The TFT substrate 102 shown in FIG. 7B has a common-top IPS structure.

In liquid crystal display devices having the source-top IPS structure, the pixel electrode PT connected to the source electrode is disposed on the upper side of the TFT substrate 102 than the common electrode CT. In liquid crystal display devices having the common-top IPS structure, the common electrode CT is disposed on the upper side of the TFT substrate than the pixel electrode PT.

Similarly to FIG. 7A, a contamination prevention film (not shown) is formed above a transparent substrate 40 such as a glass substrate, and the gate electrode film 30, the gate insulating film 45, and the silicon semiconductor film 36 are sequentially formed thereon. Moreover, the drain electrode film 31 and the source electrode film 32 are formed on the silicon semiconductor film 36. A pixel electrode PT is formed so as to overlap with the contact portion of the source electrode film 32. Moreover, an insulating film 46 and a common electrode CT are sequentially formed thereon.

In the case of the liquid crystal display device 1 having the source-top IPS structure shown in FIG. 7A, slits are formed in the pixel electrode PT similarly to the pixel electrodes PT shown in FIGS. 6A and 6B. In contrast, in the case of the liquid crystal display device 1 having the common-top IPS structure shown in FIG. 7B, the pixel electrode PT has a planar shape, and instead, slits are formed in the common electrode CT. The slits formed in the common electrode CT may have the shape of the slits shown in FIG. 6A and may have the shape of the slits shown in FIG. 6B. That is, the common electrode CT may have a single domain structure or a multi-domain structure.

The invention provides a driving method in which display control voltages are supplied to the first and second display electrodes provided in the first and second pixel circuits in accordance with the display data of the first and second pixel circuits. That is, the display control voltage supply unit also supplies a display control voltage to the second display electrode in the first write period in which the display control voltage is supplied to the first display electrode in accordance with the display data of the first pixel circuit and supplies a display control voltage to the second display electrode in accordance with the display data of the second pixel circuit in the second write period continuous to the first write period. By performing such a driving method, it is possible to suppress an abnormal change in the potential of the first display electrode occurring when the display control voltage supply unit supplies the display control voltage to the second display electrode.

Although FIG. 5 shows a case in which the scanning signal lines Gₙ and Gₙ₊₁ change to HIGH voltage at the same time in the first write period, the invention is not limited to this as long as the scanning signal line Gₙ₊₁ changes to HIGH voltage in synchronization with the time when the scanning signal line Gₙ changes to HIGH voltage. That is, it is only necessary that the display control voltage supply unit also supplies the display control voltage to the second display electrode in at least a partial period of the period in which the display control voltage supply unit supplies the display control voltage to the first display electrode in accordance with the display data of the first pixel circuit. For example, the scanning signal line Gₙ may change to HIGH voltage at the initial stage of the first write period, and after the elapse of a very small period, the scanning signal line Gₙ₊₁ may change to HIGH voltage.

In addition, although FIG. 5 shows a case in which the first write period is shorter than the second write period, the invention is not limited to this. The display control voltage supply unit supplies the display control voltage to the first and second display electrodes in the first write period. Therefore, for example, it can be considered that the load associated with the data signal wiring is larger than that when the display control voltage is supplied to one display electrode. Thus, the time required for the potential of the first display electrode to converge to a stable value increases. Considering this, the first write period may be set to be longer than the second write period.

According to the invention, an abnormal change in the potential of the first display electrode resulting from a large parasitic capacitance existing between the first display electrode and the second display electrode can be suppressed. Therefore, by applying the invention to a structure in which a large parasitic capacitance exists, the effects of the invention are more remarkable.

Therefore, the invention is more ideally applied to two display electrodes which are arranged at a close distance than two display electrodes which are positioned at a long distance. Furthermore, the invention is further more ideally applied to a display device in which as described in FIG. 2, a plurality of pixel circuits arranged on one row in the horizontal direction of the figure is disposed in the display region, two gate wirings are arranged in parallel to the plurality of pixel circuits arranged on one row, and one data signal wiring is connected to two pixel circuit among the plurality of pixel circuits arranged on one row.

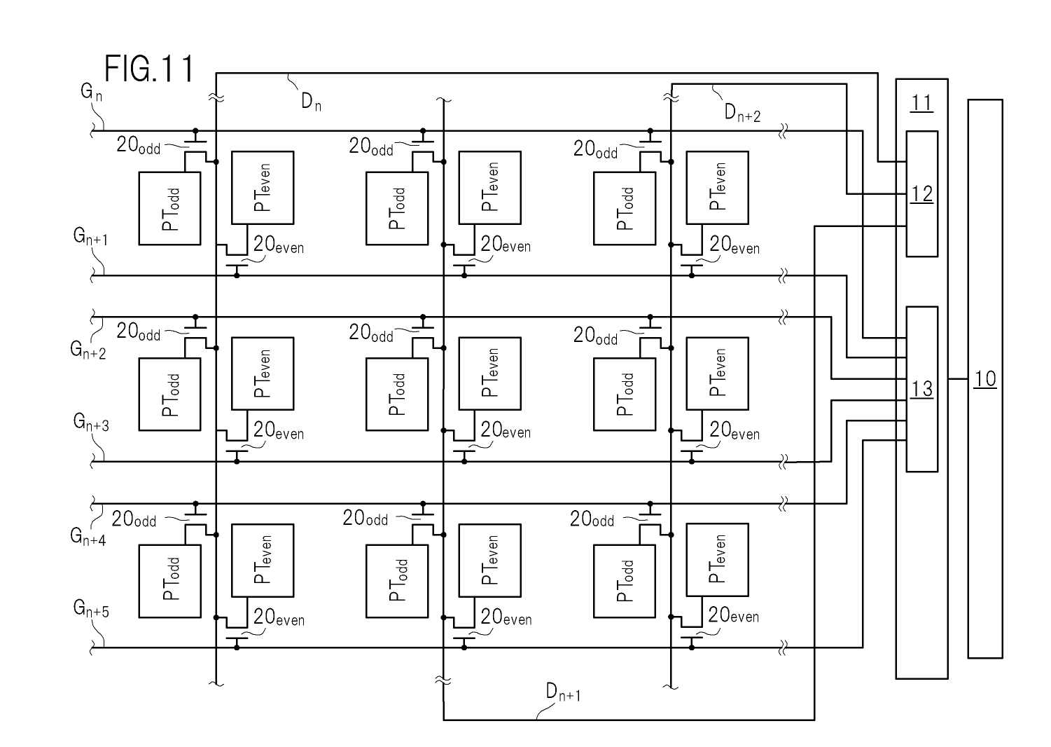

In general, in the case of the structure of the display region of the display panel shown in FIG. 12, it is necessary to arrange one data signal wiring in parallel to a plurality of pixel circuits arranged on one column in the vertical direction. When resolution increases, the number of data signal wirings increase in proportion to this, and accordingly, the space for arranging the data signal wirings in the frame region of the display panel increases, which makes it difficult to realize a narrow frame. In contrast, in the structure of the display region of the display panel shown in FIG. 2, although the number of gate wirings is doubled, it is only necessary to arrange one data signal wiring in parallel to a plurality of pixel circuits arranged on two columns in the vertical direction, and thus, the number of data signal wirings can be halved. However, when one screen (frame) of images are displayed in the same period as the display panel shown in FIG. 12, the period in which the display control voltage is supplied to the display electrode of one pixel circuit of the display panel shown in FIG. 2 is halved.

When the invention is applied to the structure of the display region, in addition to the above-mentioned effects, the following effects can be provided. Since the display control voltage supply unit supplies the display control voltage to the first and second pixel electrodes in the first write period, it is possible to further shorten the period in which the potential of the second pixel electrode converges to a stable value in the second write period than a driving method in which the display control voltage supply unit supplies display control voltages to two pixel electrodes respectively, it is possible to shorten the second write period.

Moreover, as described above, the invention can be applied to a case in which the reference potential is driven by the line inversion driving method, the frame inversion driving method, or the other driving methods, and the reference potential is maintained to be constant, as long as the reference potentials of the first and second display electrodes are the same. Particularly, since the potentials of the first and second display electrodes change abruptly after the reference potential is changed, the effects of the invention are remarkable in the driving immediately after the reference potential is changed.

Furthermore, in the case of liquid crystal display devices having the source-top structure in which the display electrodes have the multi-domain structure, since the parasitic capacitance between the first and second display electrodes is large, the effects of the invention are remarkable.

### Second Embodiment

A display device according to a second embodiment of the invention is a liquid crystal display device 1 according to one of IPS liquid crystal display devices and has the same basic configuration as the liquid crystal display device 1 according to the first embodiment. A main difference between the liquid crystal display device 1 according to this embodiment and the liquid crystal display device 1 according to the first embodiment lies in the driving method thereof.

In the display device according to the first embodiment, the abnormal change in the potential of the first display electrode occurring in the second write period is suppressed. However, even when the voltage ΔV which is the abnormal change in the potential of the first display electrode is suppressed, if the voltage ΔV remains unremoved, the voltage ΔV may cause display abnormalities in the first pixel circuit. If such display abnormalities occur systematically in the display device of the first embodiment, they result in display abnormalities such as vertical stripes, for example. That is, in the case of the display region of the display panel shown in FIG. 2, since the abnormal change occurs in the potentials of the odd pixel electrodes PT_{odd}, display abnormalities occur in the odd pixel circuits, and they will be recognized by the person's eyes as vertical stripes. In the display device according to this embodiment, display abnormalities resulting from the abnormal change in the potential of the display electrode which remains unremoved, although it is suppressed, are suppressed from being recognized by the person's eyes.

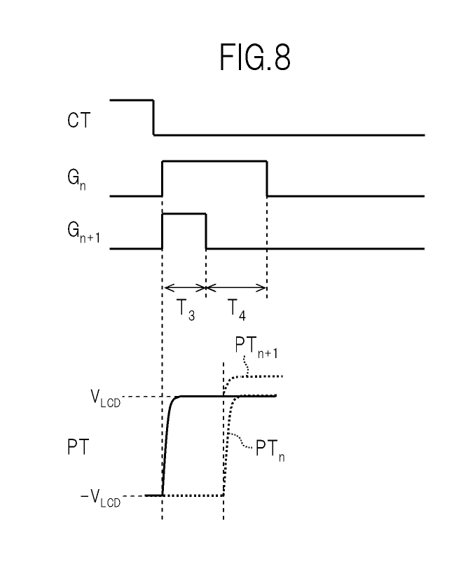

FIG. 8 is a diagram showing part of a method of driving the liquid crystal display device 1 according to this embodiment. FIG. 8 shows two pixel circuits provided in the liquid crystal display device 1 according to this embodiment, and the two pixel circuits are first and second pixel circuits similarly to FIG. 5.

In FIG. 8, the changes over time of the respective potentials of the common electrode CT, the scanning signal line Gₙ, the scanning signal line Gₙ₊₁, and the pixel electrodes PT are shown in that order from the top similarly to FIG. 5. Moreover, in FIG. 8, a case in which the display data of the two pixel circuits are the same, and the display control voltages to be supplied to the pixel electrodes PTₙ and PTₙ₋₁ are the same is shown similarly to FIG. 5.

In the driving method shown in FIG. 8, similarly to the driving method shown in FIG. 5, HIGH voltage is applied to two scanning signal lines Gₙ and Gₙ₊₁, and after that, unlike the driving method shown in FIG. 5, LOW voltage is applied to the scanning signal line Gₙ₊₁ and HIGH voltage is maintained in the scanning signal line Gₙ. A period in which the scanning signal line Gₙ₊₁ is at HIGH voltage will be referred to as a third write period, and a period which starts when the scanning signal line Gₙ₊₁ changes to LOW voltage and ends when the scanning signal line Gₙ changes to LOW voltage will be referred to as a fourth write period. In FIG. 8, the third and fourth write periods are denoted as T₃ and T₄, respectively.

In the third write period, a display control voltage corresponding to the display data of the second pixel circuit is applied to the data signal line Dₙ from the data signal driving circuit 12. In the fourth write period, a display control voltage corresponding to the display data of the first pixel circuit is applied to the data signal line Dₙ from the data signal driving circuit 12.

In the driving method shown in FIG. 5, in the first write period, two TFTs 20ₙ and 20ₙ₊₁ are turned ON together, and a display voltage is supplied to two pixel electrodes PTₙ and PTₙ₋₁ in accordance with the display data of the first pixel circuit. Moreover, in the second write period, only the TFT 20ₙ₊₁ is maintained in the ON state, and a display voltage is supplied to the pixel electrode PTₙ₊₁ in accordance with the display data of the second pixel circuit.

In contrast, in the driving method shown in FIG. 8, in the third write period corresponding to the first write period, two TFTs 20ₙ and 20ₙ₊₁ are turned ON together, and a display voltage is supplied to two pixel electrodes PTₙ and PTₙ₊₁ in accordance with the display data of the second pixel circuit. Moreover, in the fourth write period corresponding to the second write period, only the TFT 20ₙ is maintained in the ON state, and a display voltage is supplied to the pixel electrode PTₙ in accordance with the display data of the second pixel circuit.

In this way, in the driving method shown in FIG. 5, the abnormal change occurring in the potential of the pixel electrode PTₙ is suppressed in the second write period. Moreover, in the driving method shown in FIG. 8, the abnormal change occurring in the potential of the pixel electrode PTₙ₊₁ is suppressed in the fourth write period.

Even when the voltage ΔV which is the abnormal change is suppressed, if the voltage ΔV remains unremoved, the abnormal change still occurs in the potential of the pixel electrode PTₙ in the case of the driving method shown in FIG. 5 and in the potential of the pixel electrode PTₙ₊₁ in the case of the driving method shown in FIG. 8.

In the display region of the liquid crystal display device 1 according to this embodiment, a plurality of pixel circuits are arranged regularly, and images are displayed thereon. HIGH voltage is sequentially applied to a plurality of scanning signal lines Gₙ, display control voltages are applied to a plurality of data signal lines Dₙ in accordance with the display data of the corresponding pixel circuits, and the display control voltages are supplied to the pixel electrodes PT of the corresponding pixel circuits. In this way, one screen (frame) of images are displayed.

In the liquid crystal display device 1 according to this embodiment, when displaying a certain screen (frame) of images, the corresponding display control voltages are supplied to the two pixel electrodes PTₙ and PTₙ₊₁ in accordance with the driving method shown in FIG. 5. When displaying the next screen (frame) of images, the corresponding display control voltages are supplied to the two pixel electrodes PTₙ and PTₙ₊₁ in accordance with the driving method shown in FIG. 8. Here, the former screen will be referred to as the first frame, and the latter screen will be referred to as the second frame.

An abnormal change occurs in the potential of the pixel electrode PTₙ when displaying the first frame of images, and an abnormal change occurs in the potential of the pixel electrode PTₙ₋₁ when displaying the second frame of images. That is, a display abnormality occurs in the first pixel circuit when displaying the first frame of images, and a display abnormality occurs in the second pixel circuit when displaying the second frame of images. However, when displaying the subsequent screens (frames) of images, the driving method shown in FIG. 5 and the driving method shown in FIG. 8 are repeated every screen (frame). In this way, the display abnormality is alternately repeated every screen (frame) in such a way that it occurs in the first pixel circuit in one screen (frame) and in the second pixel circuit in the subsequent screen (frame). Thus, the display abnormality is averaged over time so that the display abnormality is suppressed from being recognized by the person's eyes.

Since the changes in display abnormalities repeatedly occurring at a short frequency of 60 Hz, for example, are averaged over time and not recognized by the person's eyes, it is preferable that the driving method shown in FIG. 5 and the driving method shown in FIG. 8 are repeated every screen (frame). However, the driving methods may be repeated every plural screens (frames) without being limited to repeating every screen (frame). In addition, the number of screens (frames) displayed in accordance with the driving method shown in FIG. 5 may be not always identical to the number of screens (frames) displayed in accordance with the driving method shown in FIG. 8.

Even when the abnormal change occurring in the potential of the first display electrode remains unremoved and occurs systematically in the display device according to the first embodiment so that display abnormalities such as vertical stripes are caused, in the display device according to this embodiment, the display abnormalities such as vertical stripes are suppressed from being recognized by the persons' eyes.

### Third Embodiment

A display device according to a third embodiment of the invention is a liquid crystal display device 1 according to one of IPS liquid crystal display devices and has the same basic configuration as the liquid crystal display device 1 according to the first embodiment. A main difference between the liquid crystal display device 1 according to this embodiment and the liquid crystal display device 1 according to the first embodiment lies in the driving method thereof.

As described above, in the display device according to the first embodiment, even when the voltage ΔV which is the abnormal change in the potential of the first display electrode is suppressed, if the voltage ΔV remains unremoved, the voltage ΔV may cause display abnormalities in the first pixel circuit. If such display abnormalities occur systematically in the display device of the first embodiment, they result in display abnormalities such as vertical stripes, for example, which are recognized by the person's eyes.

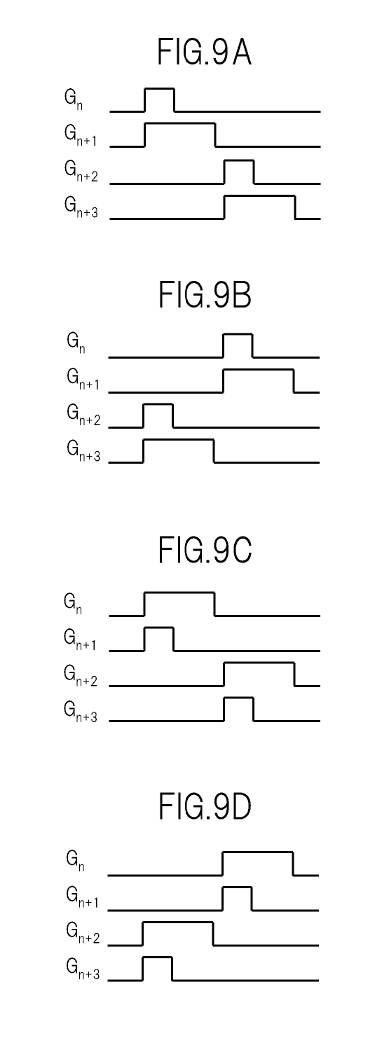

FIG. 9A is a diagram showing part of a method of driving the liquid crystal display device 1 according to this embodiment. FIG. 9A shows four pixel circuits provided in the liquid crystal display device 1 according to this embodiment, and shows a driving method when images are displayed in a normal scan mode described later.

Here, the four pixel circuits include a third pixel circuit arranged along the first pixel circuit and a fourth pixel circuit arranged along the second pixel circuit in addition to the first and second pixel circuits described above. For example, as described above, when the first and second pixel circuits are the pixel circuits which appear in the first and second places from the left side of the first row from the top of FIGS. 2 and 3, the third and fourth pixel circuits are the pixel circuits which appear in the first and second places from the left side of the second row from the top of FIGS. 2 and 3. That is, the third pixel circuit is arranged along the first pixel circuit in the vertical direction of the figure, and the fourth pixel circuit is arranged along the second pixel circuit in the vertical direction of the figure.

The pixel circuit appearing in the first place from the left side of the second row from the top of the figure is an odd pixel circuit and includes an odd TFT 20_{odd} which is a third switching element and an odd pixel electrode PT_{odd} which is a third display electrode. The odd TFT 20_{odd} and the odd pixel electrode PT_{odd} will be referred to as a TFT 20ₙ₊₂ and a pixel electrode PTₙ₊₂. Similarly, the pixel circuit appearing in the second place from the left side of the second row from the top of the figure is an even pixel circuit and includes an even TFT 20ₑᵥₑₙ which is a fourth switching element and an even pixel electrode PTₑᵥₑₙ which is a fourth display electrode. The even TFT 20ₑᵥₑₙ and the even pixel electrode PTₑᵥₑₙ will be referred to as a TFT 20ₙ₋₃ and a pixel electrode PTₙ₋₃. Moreover, as shown in FIGS. 2 and 3, similarly to the first and second pixel circuits, the scanning signal line Gₙ₊₂ which is a third gate wiring is connected to the gate electrodes of the TFT 20ₙ₊₂, and the scanning signal line Gₙ₋₃ which is a fourth gate wiring is connected to the gate electrode of the TFT 20ₙ₊₃.

In the driving method according to the related art shown in FIG. 13, generally, the control circuit 11 sequentially applies HIGH voltage to the scanning signal lines arranged in order from the top of the figure of the display region shown in FIG. 12 and applies display control voltages to the data signal lines being connected in accordance with the display data of the pixel circuits connected to the scanning signal line in a period when the scanning signal line is at HIGH voltage. A driving method in which display data of the pixel circuits are written in the top-to-bottom direction of the display region will be referred to as a normal scan mode for the sake of convenience. In contrast, a driving method in which when images being displayed in the normal scan mode are vertically reversed and displayed, display data of the pixel circuit are written in a direction reverse to the normal scan-mode writing driving method, namely in the bottom-to-top direction of the display region will be referred to as a reverse scan mode.

In the liquid crystal display device 1 according to this embodiment, when displaying images in the normal scan mode, the control circuit 11 sequentially applies HIGH voltage from the top of the figure to the scanning signal lines Gₙ arranged in order from the top of the figure of the display region shown in FIGS. 2 and 3. Specifically, as shown in FIG. 9A, in the first write period, the control circuit 11 applies HIGH voltage to two scanning signal lines Gₙ and Gₙ₊₁ together and supplies a display control voltage to two pixel electrodes PTₙ and PTₙ₊₁ in accordance with the display data of the first pixel circuit. In the second write period, the control circuit 11 maintains only the scanning signal line Gₙ₊₁ to be at HIGH voltage and supplies a display control voltage to the pixel electrode PTₙ₊₁ in accordance with the display data of the second pixel circuit.

The control circuit 11 performs the same driving method as the driving method, which the pixel circuit 11 has performed on the first and second pixel circuits in the first and second write periods, on the third and fourth pixel circuits in the third and fourth write periods continuous to the second write period. That is, in the third write period, the control circuit 11 applies HIGH voltage to two scanning signal lines Gₙ₊₂ and Gₙ₊₃ together and supplies a display control voltage to two pixel electrodes PTₙ₋₂ and PTₙ₊₃ in accordance with the display data of the third pixel circuit. In the fourth write period, the control circuit 11 maintains only the scanning signal line Gₙ₊₃ to be at HIGH voltage and supplies a display control voltage to the pixel electrode PTₙ₋₄ in accordance with the display data of the fourth pixel circuit.

By performing the driving method shown in FIG. 9A, although the abnormal changes occurring in the potentials of the pixel electrodes PTₙ and PTₙ₊₃ which are the first and third display electrodes are suppressed, if the abnormal changes remain unremoved although they are suppressed, they are recognized by the person's eyes as display abnormalities.

FIG. 9B is a diagram showing part of a method of driving the liquid crystal display device 1 according to this embodiment. FIG. 9B shows four pixel circuits provided in the liquid crystal display device 1 according to this embodiment, and shows a driving method when images are displayed in a reverse scan mode differently from FIG. 9A.

That is, the display data of the pixel circuits are written in the bottom-to-top direction of the display region as below. First, in fifth and sixth write periods, the control circuit 11 performs the driving which the pixel circuit 11 has performed on the third and fourth pixel circuits in the third and fourth write periods, on the third and fourth pixel circuits. In seventh and eighth write periods continuous to the sixth write period, the control circuit 11 performs the driving which the pixel circuit 11 has performed on the first and second pixel circuits in the first and second write periods, on the first and second pixel circuits.

By performing the driving method shown in FIG. 9B, similarly to the case of performing the driving method shown in FIG. 9A, although the abnormal changes occurring in the potentials of the pixel electrodes PTₙ and PTₙ₊₃ which are the first and third display electrodes are suppressed, if the abnormal changes remain unremoved although they are suppressed, they are recognized by the person's eyes as display abnormalities.

Actually, when displaying images, the control circuit 11 writes display data to a plurality of pixel circuits positioned over the entire screen (frame) at a short frequency of 60 Hz, for example. That is, the control circuit 11 repeatedly performs the driving method shown in FIG. 9A when displaying images in the normal scan mode and the driving method shown in FIG. 9B when displaying images in the reverse scan mode on the first to fourth pixel circuits.

Therefore, the control circuit 11 of the liquid crystal display device 1 according to this embodiment performs the driving method shown in FIG. 9A when displaying images in the normal scan mode and the driving method shown in FIG. 9B when displaying images in the reverse scan mode on the first to fourth pixel circuits. Thus, when switching from the normal (reverse) scan mode to the reverse (normal) scan mode, the same abnormal changes are left in the potentials of the same pixel electrodes PT. As a result, it is possible to maintain the display abnormalities in the same pixel circuits.

As described in the second embodiment, the changes in display abnormalities repeatedly occurring at a short frequency of 60 Hz are not recognized by the person's eyes. However, as in the case of this embodiment, if after images are displayed in the normal (reverse) scan mode for a long period, the scan mode is switched to the reverse (normal) scan mode, and images are displayed in the reverse (normal) scan mode, maintaining the display abnormalities in the same pixel circuits makes them less recognized by the person's eyes. That is, even when the abnormal change occurring in the potential of the first display electrode remains unremoved and occurs systematically in the display device according to the first embodiment so that display abnormalities such as vertical stripes are caused, in the display device according to this embodiment, the display abnormalities such as vertical stripes are suppressed in the following manner. That is, images are displayed in the normal (reverse) scan mode for a long period so that the person's eyes are made familiar with the display abnormalities such as vertical stripes. Thereafter, when the scan mode is changed and images are displayed in the reverse (normal) scan mode, the familiar display abnormalities are maintained so that they are less recognized by the person's eyes.

As a comparative example of this embodiment, a case in which the driving method shown in FIG. 9A is performed when displaying images in the normal scan mode and a driving method shown in FIG. 9D is performed when displaying images in the reverse scan mode will be considered. In the driving method shown in FIG. 9D, the driving which is performed on four scanning signal lines Gₙ, Gₙ₊₁, Gₙ₊₂, and Gₙ₊₃ shown in FIG. 9A in that order is reversed in time so that the driving is performed on the four scanning signal lines Gₙ₊₃, Gₙ₊₂, Gₙ₋₁, and Gₙ in that order. If the control circuit 11 performs the driving method shown in FIG. 9D on the first to fourth pixel circuits when displaying images in the reverse scan mode, display abnormalities occurs in the second and fourth pixel circuits. Therefore, unlike the driving method according to this embodiment, when the scan mode is changed from the normal (reverse) scan mode to the reverse (normal) scan mode, display abnormalities occur in different pixel circuits and the changes thereof are recognized by the person's eyes.

### Fourth Embodiment

A display device according to a fourth embodiment of the invention is a liquid crystal display device 1 according to one of IPS liquid crystal display devices and has the same basic configuration as the liquid crystal display device 1 according to the first embodiment. A main difference between the liquid crystal display device 1 according to this embodiment and the liquid crystal display device 1 according to the first embodiment lies in the driving method thereof. The method of driving the liquid crystal display device 1 according to this embodiment combines the driving methods according to the second and third embodiments.

FIG. 9C and FIG. 9D are diagrams showing part of a method of driving the liquid crystal display device 1 according to this embodiment. FIG. 9C shows four pixel circuits provided in the liquid crystal display device 1 according to this embodiment, and shows part of the driving method when images are displayed in a normal scan mode.

When the control circuit 11 performs the driving method shown in FIG. 9C on the first to fourth pixel circuits, display abnormalities occur in the second and fourth pixel circuits. Therefore, when displaying images in the normal scan mode, the control circuit 11 repeatedly performs the driving methods shown in FIGS. 9A and 9C on the first to fourth pixel circuits every screen (frame). By doing so, similarly to the driving method according to the second embodiment, the display abnormality is alternately repeated in such a way that it occurs in the first and third pixel circuits in one screen (frame) and in the second and fourth pixel circuits in the subsequent screen (frame). Thus, the display abnormality is averaged over time so that the display abnormality is suppressed from being recognized by the person's eyes. In contrast, when displaying images in a reverse scan mode, the control circuit 11 repeatedly performs the driving methods shown in FIGS. 9B and 9D on the first to fourth pixel circuits every screen (frame). In this way, similarly, the display abnormality is suppressed from being recognized by the person's eyes.

However, the display abnormality although it is suppressed may be recognized by the person's eyes. Nevertheless, even when the scan mode is changed from the normal (reverse) scan mode to the reverse (normal) scan mode, the pattern of the remaining display abnormality is maintained and is less recognized by the person's eyes.

Similarly to the driving method according to the second embodiment, although a case in which the driving methods shown in FIGS. 9A and 9C are repeated every screen (frame) when displaying images in the normal scan mode has been described, the driving methods may be repeated every plural screens (frames). Moreover, similarly to the driving method according to the second embodiment, the number of screens (frames) displayed in accordance with the driving method shown in FIG. 9A may be not always identical to the number of screens (frames) displayed in accordance with the driving method shown in FIG. 9C. The same statements apply to the driving methods shown in FIGS. 9B and 9D in which images are displayed in the reverse scan mode.

### Fifth Embodiment

A display device according to a fifth embodiment of the invention is a liquid crystal display device 1 according to one of IPS liquid crystal display devices and has the same basic configuration as the liquid crystal display device 1 according to the first embodiment. A main difference between the liquid crystal display device 1 according to this embodiment and the liquid crystal display device 1 according to the first embodiment lies in the driving method thereof.

As described in the liquid crystal display device 1 according to the first embodiment, the reference potential is supplied to the common electrode CT. The reference potential is driven by an AC driving method in which two potentials of positive potential and negative potential are periodically and alternately repeated. Since the data signal line Dₙ and the common electrode CT have portions which overlap with each other in plan view with the insulating film 43 or the like disposed therebetween, the portions serve as a parasitic capacitance, and capacitive coupling takes place between the data signal line Dₙ and the common electrode CT. In synchronization with the time when the potential of the common electrode CT changes, the potential of the data signal line Dₙ changes due to the capacitive coupling. Therefore, when it is necessary to maintain the potential of wirings such as the data signal line Dₙ to be at a predetermined potential, even if the control circuit 11 controls the potential of the output terminal of the corresponding data signal lines Dₙ so as to be at a predetermined potential, the potential of a data signal line distant from the output terminal of the control circuit 11 among the corresponding data signal lines Dₙ changes due to the capacitive coupling.

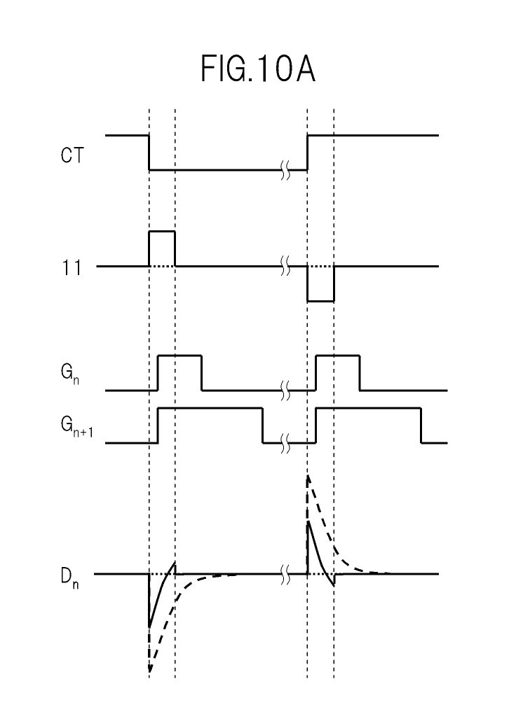

FIG. 10A is a diagram showing a method of driving the liquid crystal display device 1 according to this embodiment. FIG. 10A shows two pixel circuits provided in the liquid crystal display device 1 according to this embodiment, and the two pixel circuits are the first and second pixel circuits similarly to FIG. 5.

In FIG. 10A, the changes over time of the respective potentials of the common electrode CT, the output terminal to the data signal line Dₙ of the control circuit 11, the scanning signal line Gₙ, the scanning signal line Gₙ₊₁, and the data signal line Dₙ near the first and second pixel circuits are shown in that order from the top.

In FIG. 10A, for the sake of simplicity, a case in which the display data of the first and second pixel circuits supplied through the data signal line Dₙ by the control circuit 11 are the same, and accordingly, the display control voltages supplied by the control circuit 11 are constant over the entire period shown in the figure, and the potentials to be applied to the data signal line Dₙ are constant over the entire period shown in the figure even when the potential of the common electrode CT changes is shown. That is, a case in which the display data have an intermediate gradation is shown.

Even if the display data of the first and second pixel circuits have an intermediate gradation, and the potential to be applied to the data signal line Dₙ by the control circuit 11 in terms of the display data is constant even when the potential of the common electrode changes, as shown in FIG. 10A, the potential which the control circuit 11 applies to the data signal line Dₙ, namely the potential of the output terminal to the data signal line Dₙ of the control circuit 11 changes in synchronization with the time when the potential of the common electrode CT changes. That is, in synchronization with the time when the potential of the common electrode changes from positive potential to negative potential, the potential of the output terminal to the data signal line Dₙ of the control circuit 11 is higher than the potential corresponding to the display data of the first pixel circuit. On the other hand, in synchronization with the time when the potential of the common electrode CT changes from negative potential to positive potential, the potential of the output terminal to the data signal line Dₙ of the control circuit 11 is lower than the potential corresponding to the display data of the first pixel circuit.

As shown in FIG. 10A, the potentials of the scanning signal lines Gₙ and Gₙ₊₁ change similarly to those shown in FIG. 5. That is, the potential of the common electrode CT changes from positive potential to negative potential, and in the first write period, the control circuit 11 supplies a display control voltage to the pixel electrodes PTₙ and PTₙ₊₁ through the data signal line Dₙ.

The curves indicated by the broken lines in FIG. 10A are included for the purpose of comparison, and show the potential of the data signal line Dₙ near the first and second pixel circuits when the potential of the output terminal to the data signal line Dₙ of the control circuit 11 is constant.

As described above, in synchronization with the time when the potentials of the common electrodes CT provided in the first and second pixel circuits change from positive (negative) potential to negative (positive) potential, the potential of the data signal line Dₙ near the first and second pixel circuits decreases (increases). Accordingly, a current passes through the data signal line Dₙ in a direction from the control circuit 11 to the vicinity of the first and second pixel circuits (to the control circuit 11 from the vicinity of the first and second pixel circuits), and the potential of the data signal line Dₙ near the first and second pixel circuits increases (decreases). In the first write period, the scanning signal lines Gₙ and Gₙ₊₁ changes to HIGH voltage, and the display control voltage applied to the data signal line Dₙ is supplied to the pixel electrodes PTₙ and PTₙ₊₁ through the TFTs 20ₙ and 20ₙ₊₁ which are in the ON state.

In the liquid crystal display device 1 according to this embodiment, in synchronization with the time when the potential of the common electrode changes from positive (negative) potential to negative (positive) potential, the voltage applied to the data signal line Dₙ by the control circuit 11 becomes higher (lower) than the display control voltage corresponding to the display data of the first pixel circuit for a predetermined period. Accordingly, as compared to a case in which the display control voltage is the same as the display control voltage corresponding to the display data of the first pixel circuit, the potential of the data signal line Dₙ near the first and second pixel circuits approaches a desired potential corresponding to the display data of the first pixel circuit more quickly. Although FIG. 10A shows a case in which the display data have an intermediate gradation for the sake of simplicity, the invention can be applied to a case in which the display data has a gradation different from the intermediate gradation. Moreover, the duration of the predetermined period and the difference between the voltage and the display control voltage corresponding to the display data of the first pixel circuit may be determined considering the magnitude of the capacitance (capacitance Cₛₜ) between the pixel electrode PT and the common electrode CT, the internal resistance of the data signal line Dₙ, the performance of the control circuit 11, and the like.

As a result, when the display control voltages applied to the data signal line Dₙ are supplied to the pixel electrodes PTₙ and PTₙ₊₁ through the TFTs 20ₙ and 20ₙ₊₁ which are in the ON state in the first write period, the potentials of the pixel electrodes PTₙ and PTₙ₊₁ can converge to a desired potential more quickly.

Therefore, if the write period which is the period in which the scanning signal line Gₙ changes to HIGH voltage, and the display control voltage is supplied to the pixel electrode PT is the same as the write period according to the related art, the potential of the pixel electrode PT can converge to a desired potential more stably, and the display quality can be improved. Moreover, when it is only necessary to make the potential of the pixel electrode converge with the same accuracy as the related art, it is possible to shorten the write period and to realize a high-definition display panel.

As described above, as compared to the structure of the display panel shown in FIG. 12, the number of data signal wirings can be halved in the structure of the display region of the display panel shown in FIG. 2. On the other hand, when one screen (frame) of images are displayed in the same period as the display panel shown in FIG. 12, display control voltages are supplied to two pixel electrodes PT shown in FIG. 2 in a period in which display control voltage is supplied to one pixel electrode PT shown in FIG. 12. Therefore, the effects of the invention are more remarkable in this embodiment in that the potential of the pixel electrode can converge to a desired potential more quickly. Moreover, as compared to the liquid crystal display device 1 having the source-top IPS structure shown in FIG. 7A, in the liquid crystal display device 1 having the common-top IPS structure shown in FIG. 7B, since the distance between the pixel electrode PT and the common electrode CT decreases, the capacitance between the pixel electrode PT and the common electrode CT increases. Therefore, in the liquid crystal display device 1 having a common-top IPS structure, although it takes longer time for the potential of the pixel electrode PT to converge to a desired potential, the convergence time can be shortened by applying the invention according to this embodiment.

Furthermore, in the liquid crystal display device 1 according to this embodiment, in the first write period, the control circuit 11 supplies the display control voltage to the pixel electrode PTₙ₋₁ of the second pixel circuit as well as the pixel electrode PTₙ of the first pixel circuit through the data signal line Dₙ. Therefore, as compared to the driving method according to the related art shown in FIG. 13, the load applied to the control circuit 11 in the first write period increases. That is, it is difficult to maintain the data signal line Dₙ near the first and second pixel circuits to be at a desired potential. However, since the control circuit 11 performs the driving as shown in FIG. 10A, the potential of the data signal line Dₙ near the first and second pixel circuits can be controlled more stably.

The invention according to this embodiment realizes a display device in which the display quality is further improved by suppressing the abnormal change in the potential of the data signal line Dₙ occurring when the reference potential changes. The effects of the invention are more remarkable as the reference potential changes more frequently. Therefore, the effects of the invention are more remarkable when the reference potential is driven by the line inversion driving method since the potential of the data signal line Dₙ changes more frequently. However, even when the reference potential is driven by the frame inversion driving method, the invention according to this embodiment can be applied by applying the invention in synchronization with the time when the reference potential of the entire frame changes from positive (negative) potential to negative (positive) potential. The invention according to this embodiment can be also applied to other driving methods when the reference potential changes from positive (negative) potential to negative (positive) potential.

Hereinabove, the display device according to the embodiment of the invention has been described. The invention is different from the related art in that the driving method by the display control voltage supply unit is different. That is, the object of the invention can be attained without adding restrictions regarding the product design such as changes in processes when manufacturing the display device according to the invention.

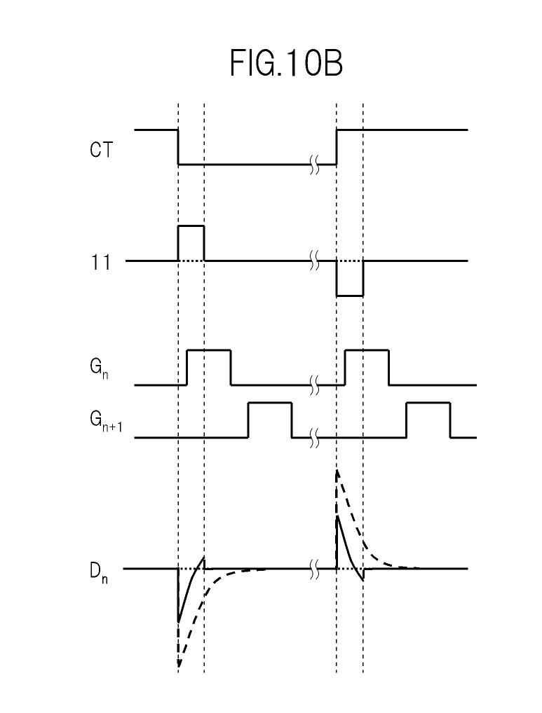

Although an IPS liquid crystal display device has been describe as an example of the display device according to the embodiments of the invention, the invention maybe applied to other liquid crystal display devices having other driving methods such as other IPS methods, VA (Vertically Aligned) methods, or TN (Twisted Nematic) methods, and may be applied to other display devices. FIG. 11 is a diagram showing an equivalent circuit of the TFT substrate 102 of the liquid crystal display device 1 according to another embodiment of the invention. The liquid crystal display device 1 is a VA or TN-mode liquid crystal display device, and in the VA or TN method, a common electrode CT (not shown) is formed on a surface of the filter substrate 101 facing the TFT substrate 102, and a pixel electrode PT has a planar shape.

FIG. 10B is a diagram showing a method of driving the liquid crystal display device according to the related art of the invention. The driving method shown in FIG. 10B has the same basic configuration as that of the liquid crystal display device 1 shown in FIG. 10A except in the following respects.

In FIG. 10B, similarly to FIG. 10A, the changes over time of the respective potentials of the common electrode CT, the output terminal to the data signal line Dₙ of the control circuit 11, the scanning signal line Gₙ, the scanning signal line Gₙ₊₁, and the data signal line Dₙ near the first and second pixel circuits are shown in that order from the top. However, in FIG. 10B, unlike the driving method shown in FIG. 10A, the scanning signal lines Gₙ and Gₙ₋₁ sequentially change to HIGH voltage, which is the same as the driving method according to the related art shown in FIG. 13.

Similarly to the case shown in FIG. 10A, the changes in the potential of the data signal line Dₙ occurring when the reference potential changes are suppressed, and the potentials of the corresponding display electrodes can converge to a desired potential more quickly.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a first pixel circuit comprising a first switching element and a first display electrode;
a second pixel circuit comprising a second switching element and a second display electrode; and
a display control voltage supply unit supplying a display control voltage to the first and second display electrodes through the first and second switching elements, respectively,
wherein in a first write period, the display control voltage supply unit turns ON a switch of the first switching element, supplies a display control voltage corresponding to display data of the first pixel circuit to the first display electrode, turns ON a switch of the second switching element in synchronization with the time when the switch of the first switching element is turned ON, and supplies the display control voltage corresponding to the display data of the first pixel circuit to the second display electrode, and
wherein in a second write period continuous to the first write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

2. The display device according to claim 1,
wherein in a third write period after the first and second write periods, the display control voltage supply unit turns ON the switch of the second switching element, supplies a display control voltage corresponding to display data of the second pixel circuit to the second display electrode, turns ON the switch of the first switching element in synchronization with the time when the switch of the second switching element is turned ON, and supplies the display control voltage corresponding to the display data of the second pixel circuit to the first display electrode, and
wherein in a fourth write period continuous to the third write period, the display control voltage supply unit maintains the switch of the first switching element to be in the ON state, turns OFF the switch of the second switching element, and supplies a display control voltage corresponding to display data of the first pixel circuit to the first display electrode in synchronization with the time when the switch of the second switching element is turned OFF.

3. The display device according to claim 2,
wherein the display control voltage supply unit alternately repeats the control performed in the first and second write periods and the control performed in the third and fourth write periods to thereby sequentially supply display control voltages corresponding to display data of the first and second pixel circuits to the first and second display electrodes in synchronization with the time when the display control voltage is supplied to the first and second display electrodes.

4. The display device according to claim 1,
wherein output sides of the first and second switching elements are connected to the first and second display electrodes, respectively,
wherein the display control voltage supply unit further comprises a data signal wiring connected to each of input sides of the first and second switching elements, and
wherein the display control voltage supply unit applies a display control voltage to the data signal wiring to thereby supply the display control voltage to a display electrode connected to an output side of a switching element being in the ON state among the first and second switching elements.

5. The display device according to claim 4,
wherein the display control voltage supply unit further comprises a first gate wiring connected to the switch of the first switching element and a second gate wiring connected to the switch of the second switching element, and
wherein the display control voltage supply unit applies an ON voltage to the first and second gate wirings to thereby turn ON the switches of the first and second switching elements, respectively.

6. The display device according to claim 1, further comprising:
a third pixel circuit comprising a third switching element and a third display electrode and arranged along the first pixel circuit; and
a fourth pixel circuit comprising a fourth switching element and a fourth display electrode and arranged along the second pixel circuit,
wherein the display control voltage supply unit supplies a display control voltage to the third and fourth display electrodes through the third and fourth switching elements, respectively,
wherein when displaying images in a normal scan mode,
in a third write period continuous to the second write period, the display control voltage supply unit turns ON a switch of the third switching element, supplies a display control voltage corresponding to display data of the third pixel circuit to the third display electrode, turns ON a switch of the fourth switching element in synchronization with the time when the switch of the third switching element is turned ON, supplies the display control voltage corresponding to the display data of the third pixel circuit to the fourth display electrode,
in a fourth write period continuous to the third write period, the display control voltage supply unit maintains the switch of the fourth switching element to be in the ON state, turns OFF the switch of the third switching element, and supplies a display control voltage corresponding to display data of the fourth pixel circuit to the fourth display electrode in synchronization with the time when the switch of the third switching element is turned OFF, and
wherein when displaying images in a reverse scan mode where the images are displayed in a reversed manner,
in a fifth write period, the display control voltage supply unit turns ON the switch of the third switching element, supplies a display control voltage corresponding to display data of the third pixel circuit to the third display electrode, turns ON the switch of the fourth switching element in synchronization with the time when the switch of the third switching element is turned ON, and supplies the display control voltage corresponding to the display data of the third pixel circuit to the fourth display electrode,
in a sixth write period continuous to the fifth write period, the display control voltage supply unit maintains the switch of the fourth switching element to be in the ON state, turns off the switch of the third switching element, and supplies a display control voltage corresponding to display data of the fourth pixel circuit to the fourth display electrode in synchronization with the time when the switch of the third switching element is turned OFF,
in a seventh write period continuous to the sixth write period, the display control voltage supply unit turns ON the switch of the first switching element, supplies a display control voltage corresponding to display data of the first pixel circuit to the first display electrode, turns ON the switch of the second switching element in synchronization with the time when the switch of the first switching element is turned ON, and supplies the display control voltage corresponding to the display data of the first pixel circuit to the second display electrode, and
in an eighth write period continuous to the seventh write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

7. The display device according to claim 6,
wherein output sides of the first to fourth switching elements are connected to the first to fourth display electrodes, respectively,
wherein the display control voltage supply unit further comprises a data signal wiring connected to each of input sides of the first to fourth switching elements, and
wherein the display control voltage supply unit applies a display control voltage to the data signal wiring to thereby supply the display control voltage to a display electrode connected to an output side of a switching element being in the ON state among the first to fourth switching elements.

8. The display device according to claim 7,
wherein the display control voltage supply unit further comprises a first gate wiring connected to the switch of the first switching element;
a second gate wiring connected to the switch of the second switching element;
a third gate wiring connected to the switch of the third switching element; and
a fourth gate wiring connected to the switch of the fourth switching element, and
wherein the display control voltage supply unit applies an ON voltage to the first to fourth gate wirings to thereby turn ON the switches of the first to fourth switching elements, respectively.

9. The display device according to claim 1,
wherein output sides of the first and second switching elements are connected to the first and second display electrodes, respectively,
wherein the display control voltage supply unit further comprises a data signal wiring connected to each of input sides of the first and second switching elements, and
wherein the display control voltage supply unit supplies a different voltage from a display voltage corresponding to display data of the first pixel circuit to the data signal line in synchronization with the time when a reference potential serving as the reference of the display control voltage supplied to the first and second pixel electrodes changes to a different potential.

10. The display device according to claim 9,
wherein the different voltage is a voltage higher than the display voltage corresponding to the display data of the first pixel circuit when the reference voltage changes from a high voltage to a low voltage and is a voltage lower than the display voltage corresponding to the display data of the first pixel circuit when the reference voltage changes from a low voltage to a high voltage.

11. A method of driving a display device comprising,
a first pixel circuit comprising a first switching element and a first display electrode;
a second pixel circuit comprising a second switching element and a second display electrode; and
a display control voltage supply unit supplying a display control voltage to the first and second display electrodes through the first and second switching elements, respectively, the method comprising:
a step wherein in a first write period, the display control voltage supply unit turns ON a switch of the first switching element, supplies a display control voltage corresponding to display data of the first pixel circuit to the first display electrode, turns ON a switch of the second switching element in synchronization with the time when the switch of the first switching element is turned ON, and supplies the display control voltage corresponding to the display data of the first pixel circuit to the second display electrode, and
a step wherein in a second write period continuous to the first write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

12. The method according to claim 11, further comprising:
a step wherein in a third write period after the first and second write periods, the display control voltage supply unit turns ON the switch of the second switching element, supplies a display control voltage corresponding to display data of the second pixel circuit to the second display electrode, turns ON the switch of the first switching element in synchronization with the time when the switch of the second switching element is turned ON, and supplies the display control voltage corresponding to the display data of the second pixel circuit to the first display electrode, and
a step wherein in a fourth write period continuous to the third write period, the display control voltage supply unit maintains the switch of the first switching element to be in the ON state, turns OFF the switch of the second switching element, and supplies a display control voltage corresponding to display data of the first pixel circuit to the first display electrode in synchronization with the time when the switch of the second switching element is turned OFF.

13. The method according to claim 12,
wherein the display control voltage supply unit alternately repeats the steps for the control performed in the first and second write periods and the steps for the control performed in the third and fourth write periods to thereby sequentially supply display control voltages corresponding to display data of the first and second pixel circuits to the first and second display electrodes in synchronization with the time when the display control voltage is supplied to the first and second display electrodes.

14. The method according to claim 11,
wherein output sides of the first and second switching elements are connected to the first and second display electrodes, respectively,
wherein the display control voltage supply unit further comprises a data signal wiring connected to each of input sides of the first and second switching elements, and
wherein in the respective steps, the display control voltage supply unit applies a display control voltage to the data signal wiring to thereby supply the display control voltage to a display electrode connected to an output side of a switching element being in the ON state among the first and second switching elements.

15. The method according to claim 14,
wherein the display control voltage supply unit further comprises a first gate wiring connected to the switch of the first switching element and a second gate wiring connected to the switch of the second switching element, and
wherein in the respective steps, the display control voltage supply unit applies an ON voltage to the first and second gate wirings to thereby turn ON the switches of the first and second switching elements, respectively.

16. The method according to claim 11,
wherein the display device further comprises:
a third pixel circuit comprising a third switching element and a third display electrode and arranged along the first pixel circuit; and
a fourth pixel circuit comprising a fourth switching element and a fourth display electrode and arranged along the second pixel circuit,
wherein the display control voltage supply unit supplies a display control voltage to the third and fourth display electrodes through the third and fourth switching elements, respectively,
wherein when displaying images in a normal scan mode, the method further comprises,
a step wherein in a third write period continuous to the second write period, the display control voltage supply unit turns ON a switch of the third switching element, supplies a display control voltage corresponding to display data of the third pixel circuit to the third display electrode, turns ON a switch of the fourth switching element in synchronization with the time when the switch of the third switching element is turned ON, supplies the display control voltage corresponding to the display data of the third pixel circuit to the fourth display electrode,
a step wherein in a fourth write period continuous to the third write period, the display control voltage supply unit maintains the switch of the fourth switching element to be in the ON state, turns OFF the switch of the third switching element, and supplies a display control voltage corresponding to display data of the fourth pixel circuit to the fourth display electrode in synchronization with the time when the switch of the third switching element is turned OFF, and
wherein when displaying images in a reverse scan mode where the images are displayed in a reversed manner, the method further comprises,
a step wherein in a fifth write period, the display control voltage supply unit turns ON the switch of the third switching element, supplies a display control voltage corresponding to display data of the third pixel circuit to the third display electrode, turns ON the switch of the fourth switching element in synchronization with the time when the switch of the third switching element is turned ON, and supplies the display control voltage corresponding to the display data of the third pixel circuit to the fourth display electrode,
a step wherein in a sixth write period continuous to the fifth write period, the display control voltage supply unit maintains the switch of the fourth switching element to be in the ON state, turns off the switch of the third switching element, and supplies a display control voltage corresponding to display data of the fourth pixel circuit to the fourth display electrode in synchronization with the time when the switch of the third switching element is turned OFF,
a step wherein in a seventh write period continuous to the sixth write period, the display control voltage supply unit turns ON the switch of the first switching element, supplies a display control voltage corresponding to display data of the first pixel circuit to the first display electrode, turns ON the switch of the second switching element in synchronization with the time when the switch of the first switching element is turned ON, and supplies the display control voltage corresponding to the display data of the first pixel circuit to the second display electrode, and
a step wherein in an eighth write period continuous to the seventh write period, the display control voltage supply unit maintains the switch of the second switching element to be in the ON state, turns OFF the switch of the first switching element, and supplies a display control voltage corresponding to display data of the second pixel circuit to the second display electrode in synchronization with the time when the switch of the first switching element is turned OFF.

17. The method according to claim 16,
wherein output sides of the first to fourth switching elements are connected to the first to fourth display electrodes, respectively,
wherein the display control voltage supply unit further comprises a data signal wiring connected to each of input sides of the first to fourth switching elements, and
wherein in the respective steps, the display control voltage supply unit applies a display control voltage to the data signal wiring to thereby supply the display control voltage to a display electrode connected to an output side of a switching element being in the ON state among the first to fourth switching elements.

18. The method according to claim 17,
wherein the display control voltage supply unit further comprises a first gate wiring connected to the switch of the first switching element;
a second gate wiring connected to the switch of the second switching element;
a third gate wiring connected to the switch of the third switching element; and
a fourth gate wiring connected to the switch of the fourth switching element, and
wherein in the respective steps, the display control voltage supply unit applies an ON voltage to the first to fourth gate wirings to thereby turn ON the switches of the first to fourth switching elements, respectively.

19. The method according to claim 11,
wherein output sides of the first and second switching elements are connected to the first and second display electrodes, respectively,
wherein the display control voltage supply unit further comprises a data signal wiring connected to each of input sides of the first and second switching elements, and
wherein the method further comprises a step wherein the display control voltage supply unit supplies a different voltage from a display voltage corresponding to the display data of the first pixel circuit to the data signal line in synchronization with the time when a reference potential serving as the reference of the display control voltage supplied to the first and second pixel electrodes changes to a different potential.

20. The method according to claim 19,
wherein the different voltage is a voltage higher than the display voltage corresponding to the display data of the first pixel circuit when the reference voltage changes from a high voltage to a low voltage and is a voltage lower than the display voltage corresponding to the display data of the first pixel circuit when the reference voltage changes from a low voltage to a high voltage.
